(19) United States
(12) Patent Application Publication
(10) Pub. No.: US 2026/0299451 A1
(43) Pub. Date: Oct. 1, 2026

(54) ELECTROSTATIC CHARGE IMAGE DEVELOPING TONER SET, ELECTROSTATIC CHARGE IMAGE DEVELOPER SET, TONER CARTRIDGE SET, PROCESS CARTRIDGE, AND IMAGE FORMING APPARATUS

(71) Applicant: FUJIFILM Business Innovation Corp., Tokyo (JP)

(72) Inventors: Tomoaki TANAKA, Kanagawa (JP); Tsuyoshi Murakami, Kanagawa (JP); Kotaro Yoshihara, Kanagawa (JP); Asafumi Fujita, Kanagawa (JP)

(73) Assignee: FUJIFILM Business Innovation Corp., Tokyo (JP)

(21) Appl. No.: 19/312,619

(22) Filed: Aug. 28, 2025

(30) Foreign Application Priority Data
Mar. 26, 2025 (JP) 2025-052631

(51) Int. Cl. G03G 9/09; G03G 9/08; G03G 15/08; G03G 21/18

(52) U.S. Cl. CPC G03G 9/091; G03G 9/0819; G03G 15/0865; G03G 21/1814; G03G 2215/0607

(57) ABSTRACT

An electrostatic charge image developing toner set includes a fluorescent toner including fluorescent toner particles containing a fluorescent colorant having an azomethine structure; and a non-fluorescent toner including non-fluorescent toner particles that contain a non-fluorescent colorant but do not contain a fluorescent colorant, in which the fluorescent toner particles and the non-fluorescent toner particles contain an S element, and when measured by X-ray fluorescence analysis, an X-ray fluorescence intensity CI_{F} of the S element contained in the fluorescent toner particles and an X-ray fluorescence intensity CI_{C} of the S element contained in the non-fluorescent toner particles satisfy a relationship CI_{F}<CI_{C}.

### CROSS-REFERENCE TO RELATED APPLICATIONS

This application is based on and claims priority under 35 USC 119 from Japanese Patent Application No. 2025-052631 filed Mar. 26, 2025.

### BACKGROUND

### (i) Technical Field

The present disclosure relates to an electrostatic charge image developing toner set, an electrostatic charge image developer set, a toner cartridge set, a process cartridge, and an image forming apparatus.

### (ii) Related Art

Methods of visualizing image information, such as an electrophotographic method, are currently used in various fields. In such an electrophotographic method, the surface of an image holding member is charged, and then an electrostatic charge image is formed as image information. A toner image is formed on the surface of the image holding member by using a developer containing a toner. The toner image is transferred to a recording medium and then fixed to the recording medium. Through these steps, the image information is visualized as an image.

For example, Japanese Unexamined Patent Application Publication No. 2022-180131 discloses “an electrostatic charge image developing toner containing toner particles having a total net intensity NA of alkali metal elements and alkaline earth metal elements of 0.10 kcps or more and 1.30 kcps or less as measured by X-ray fluorescence analysis”.

Japanese Unexamined Patent Application Publication No. 2022-181100 discloses “a method for producing a toner having an ammonium ion content of 1.0 mg/L or less, and a Net intensity of Na element of 0.50 kcps or less and a Net intensity of S element of 1.50 kcps or less in X-ray fluorescence analysis”.

### SUMMARY

Aspects of non-limiting embodiments of the present disclosure relate to providing an electrostatic charge image developing toner set in which a decrease in the secondary transfer efficiency of a multilayer toner image of a fluorescent toner image and a non-fluorescent toner image is suppressed, compared with the electrostatic charge image developing toner set including a fluorescent toner including fluorescent toner particles containing a fluorescent colorant having an azomethine structure and a non-fluorescent toner including non-fluorescent toner particles that contain a non-fluorescent colorant but do not contain a fluorescent colorant, wherein when measured by X-ray fluorescence analysis, an X-ray fluorescence intensity CI_{F} of an S element contained in the fluorescent toner particles and an X-ray fluorescence intensity CI_{C} of an S element contained in the non-fluorescent toner particles satisfy a relationship CI_{F}>CI_{C}.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic charge image developing toner set including a fluorescent toner including fluorescent toner particles containing a fluorescent colorant having an azomethine structure and a non-fluorescent toner including non-fluorescent toner particles that contain a non-fluorescent colorant but do not contain a fluorescent colorant, wherein the fluorescent toner particles and the non-fluorescent toner particles contain an S element, and when measured by X-ray fluorescence analysis, an X-ray fluorescence intensity CI_{F} of the S element contained in the fluorescent toner particles and an X-ray fluorescence intensity CI_{C} of the S element contained in the non-fluorescent toner particles satisfy a relationship CI_{F}<CI_{C}.

### BRIEF DESCRIPTION OF THE DRAWINGS

Exemplary embodiments of the present disclosure will be described in detail based on the following figures, wherein:

FIG. 1 is a schematic configuration view illustrating an example of an image forming apparatus according to the present exemplary embodiment; and

FIG. 2 is a schematic configuration view illustrating an example of a process cartridge to be attached to and detached from the image forming apparatus according to the present exemplary embodiment.

### DETAILED DESCRIPTION

Hereinafter, exemplary embodiments of the present disclosure will be described. These descriptions and examples are intended to be illustrative of the exemplary embodiments and are not intended to limit the scope of the exemplary embodiments.

In the present specification, a numerical range expressed using “to” means the range that includes the values described before and after “to” as the minimum and maximum values, respectively.

In numerical ranges described stepwise in the present specification, an upper limit value or a lower limit value described in one numerical range may be replaced with an upper limit value or a lower limit value of another stepwise numerical range. In a numerical range described in the present specification, the upper limit value or lower limit value in the numerical range may be replaced with a value presented in Examples.

In the present specification, the term “step” includes not only an independent step but also a step that cannot be clearly distinguished from another step as long as the purpose of the step is achieved.

In the present specification, when an exemplary embodiment is described with reference to the drawings, the configuration of the exemplary embodiment is not limited to the configuration illustrated in the drawings. The sizes of the members in the drawings are conceptual and do not limit the relative relationship in size between the members.

In the present specification, each component may contain a plurality of kinds of corresponding substances. In the present disclosure, when referring to the amount of each component in a composition, in a case where a plurality of kinds of substances corresponding to each component are present in the composition, the amount means the total amount of the plurality of kinds of substances present in the composition unless otherwise stated.

In the present specification, each component may include a plurality of kinds of particles that correspond to the component. In a case where a plurality of kinds of particles corresponding to each component are present in a composition, the particle diameter of each component means a value for a mixture of the plurality of kinds of particles present in the composition unless otherwise stated.

### Electrostatic Charge Image Developing Toner Set

An electrostatic charge image developing toner set (hereinafter also referred to as a “toner set”) according to the present exemplary embodiment includes a fluorescent toner including fluorescent toner particles containing a fluorescent colorant having an azomethine structure (hereinafter also referred to as an “azomethine fluorescent colorant”) and a non-fluorescent toner including non-fluorescent toner particles that contain a non-fluorescent colorant but do not contain a fluorescent colorant.

The fluorescent toner particles and the non-fluorescent toner particles each contain an S element.

When measured by X-ray fluorescence analysis, the X-ray fluorescence intensity CI_{F} of the S element contained in the fluorescent toner particles and the X-ray fluorescence intensity CI_{C} of the S element contained in the non-fluorescent toner particles satisfy the relationship CI_{F}<CI_{C}.

Since the toner set according to the present exemplary embodiment has the above configuration, a decrease in the secondary transfer efficiency of a multilayer toner image of a fluorescent toner image and a non-fluorescent toner image is reduced. The reason for this is presumed to be as follows.

In the related art, it is known to use a toner to which a pigment containing a fluorescent colorant is applied for widening the color gamut of images (hereinafter also referred to as a “fluorescent toner”).

Specifically, images having various color gamuts can be formed by transferring and fixing a multilayer toner image of a fluorescent toner image and a non-fluorescent toner image to a recording medium.

On the other hand, a technique of incorporating an S element into toner particles is also known.

When the toner particles contain an S element, moisture is likely to adsorb to the S element present on the surfaces of the toner particles, and a conductive path is easily formed between the S element and water molecules. As a result, the occurrence of charge exchange reduces an excessive increase in charging even in a low-temperature and low-humidity environment. This can suppress density unevenness in an image with high image density when a multilayer toner image formed by stacking toners of various colors is transferred and fixed to a recording medium.

However, with fluorescent toner particles containing an azomethine fluorescent colorant, a conductive path is easily formed also between the fluorescent colorant and water molecules. This is because the azomethine fluorescent colorant is a cationic colorant, has an N—N bond containing an N atom having high electrical polarity, and forms a conductive path between the N atom and water molecules. Therefore, when the fluorescent toner particles contain an excessive amount of the azomethine fluorescent colorant, a conductive path is formed between the azomethine fluorescent colorant and water molecules, resulting in excessive charge exchange and an unnecessary decrease in charging. Furthermore, the azomethine fluorescent colorant has high affinity for a sulfonic acid-based surfactant containing an S element, and a conductive path is easily formed because of a synergistic effect with the S element.

When the non-fluorescent toner particles and the fluorescent toner particles contain the same amount of the S element, the fluorescent toner has a lower charge retention than the non-fluorescent toner.

Therefore, when a multilayer toner image of a fluorescent toner image and a non-fluorescent toner image is secondarily transferred to a recording medium, a transfer failure occurs because of a difference in charge retention between the non-fluorescent toner particles and the fluorescent toner particles, which decreases the secondary transfer efficiency. As a result, it is difficult to obtain an image having an intended chroma.

In contrast, in the toner set according to the present exemplary embodiment, the X-ray fluorescence intensity CI_{F} of the S element contained in the fluorescent toner particles and the X-ray fluorescence intensity CI_{C} of the S element contained in the non-fluorescent toner particles satisfy a relationship CI_{F}<CI_{C}. That is, the amount of the S element contained in the fluorescent toner particles is set to be smaller than the amount of the S element contained in the non-fluorescent toner particles. As a result, the charge retention of the fluorescent toner and the charge retention of the non-fluorescent toner are brought close to each other.

Therefore, a transfer failure of the multilayer toner image of the fluorescent toner image and the non-fluorescent toner image is less likely to occur, and a decrease in secondary transfer efficiency can be reduced.

It is presumed from the above description that, with the toner set according to the present exemplary embodiment, a decrease in the secondary transfer efficiency of a multilayer toner image of a fluorescent toner image and a non-fluorescent toner image can be reduced. As a result, an image having an intended chroma can be formed.

Hereinafter, toners of the toner set according to the present exemplary embodiment will be described in detail.

In the following description, common features between the fluorescent toner or the fluorescent toner particles and the non-fluorescent toner or the non-fluorescent toner particles will be described by being simply referred to as “toner or toner particles” or will be described without being specified.

### X-ray Fluorescence Intensity of Sulfur (S) Element

When measured by X-ray fluorescence analysis, the X-ray fluorescence intensity CI_{F}(unit: kcps) of an S element contained in the fluorescent toner particles and the X-ray fluorescence intensity CI_{C} (unit: kcps) of an S element contained in the non-fluorescent toner particles satisfy a relationship CI_{F}<CI_{C}.

To be specific, the difference (CI_{C}−CI_{F}) between the X-ray fluorescence intensity CI_{F} of the S element contained in the fluorescent toner particles and the X-ray fluorescence intensity CI_{C} of the S element contained in the non-fluorescent toner particles is preferably 0.3 kcps or more and 0.8 kcps or less, more preferably 0.4 kcps or more and 0.7 kcps or less, still more preferably 0.5 kcps or more and 0.6 kcps or less.

When the difference (CI_{C}−CI_{F}) is within the above range and the X-ray fluorescence intensity CI_{F} of the S element contained in the fluorescent toner particles is lower than the X-ray fluorescence intensity CI_{C} of the S element contained in the non-fluorescent toner particles, the fluorescent toner and the non-fluorescent toner have the same or similar charge retention. Therefore, the transfer failure of the multilayer toner image of the fluorescent toner image and the non-fluorescent toner image is less likely to occur, and a decrease in secondary transfer efficiency can be easily reduced.

The X-ray fluorescence intensity CI_{F} of the S element contained in the fluorescent toner particles is preferably 0.4 kcps or more and 0.9 kcps or less, more preferably 0.5 kcps or more and 0.8 kcps or less, still more preferably 0.6 kcps or more and 0.7 kcps or less.

When the X-ray fluorescence intensity CI_{F} of the S element contained in the fluorescent toner particles is within the above range, the charge retention of the fluorescent toner is likely to be moderately ensured. Therefore, the transfer failure of the multilayer toner image of the fluorescent toner image and the non-fluorescent toner image is less likely to occur, and a decrease in secondary transfer efficiency can be easily reduced.

Examples of sources for supplying the S element in the fluorescent toner particles and the non-fluorescent toner particles include sulfur-containing additives (e.g., surfactants). Specific examples of the sources for supplying the S element include sulfate derivatives (e.g., metal sulfate and metal sulfides) and sulfonates (e.g., metal dodecylbenzenesulfonate and metal dodecylsulfate).

The X-ray fluorescence intensity of the S element contained in each of the fluorescent toner particles and the non-fluorescent toner particles is adjusted by, for example, the type and amount of the sulfur-containing additive to be added, and the washing conditions (e.g., amount of water and time) and drying conditions (e.g., temperature and time) for the toner particles during production of the toner particles.

The X-ray fluorescence intensity of the S element contained in each of the fluorescent toner particles and the non-fluorescent toner particles is measured as follows.

First, toner particles to be measured (or a toner containing an external additive) are compression-molded to obtain a measurement sample.

The measurement sample is analyzed by X-ray fluorescence analysis (XRF) under the following measurement conditions to measure the intensity of a peak derived from the S element (i.e., X-ray fluorescence intensity).

### Measurement Conditions

Analyzer: X-ray fluorescence spectrometer (“XRF-1500” manufactured by Shimadzu Corporation)
X-ray tube (X-ray source): rhodium (Rh)
Excitation conditions: tube voltage 40 kV, tube current 90 mA
Measurement region (X-ray irradiation range): 30 mm in diameter
Measured element: S (sulfur)

### Particle Diameter of Toner Particles

The volume-average particle diameter D_{F} of the fluorescent toner particles and the volume-average particle diameter D_{C} of the non-fluorescent toner particles preferably satisfy the relationship D_{C}<D_{F}.

For the toner particles, as the particle diameter increases, the surface area decreases, and the amount of moisture adsorbed decreases. As a result, a decrease in the charge retention of the toner particles is likely to be reduced.

Therefore, when the volume-average particle diameter D_{F} of the fluorescent toner particles is larger than the volume-average particle diameter D_{C} of the non-fluorescent toner particles, a decrease in the charge retention of the fluorescent toner particles due to the S element is reduced. This causes the fluorescent toner and the non-fluorescent toner to have the same or similar charge retention. Thus, the transfer failure of the multilayer toner image of the fluorescent toner image and the non-fluorescent toner image is less likely to occur, and a decrease in secondary transfer efficiency can be easily reduced.

Specifically, the difference (D_{F}−D_{C}) between the volume-average particle diameter D_{F} of the fluorescent toner particles and the volume-average particle diameter D_{C} of the non-fluorescent toner particles is preferably 0.3 μm or more and 1.8 μm or less, more preferably 0.5 μm or more and 1.6 μm or less, still more preferably 0.7 μm or more and 1.4 μm or less. When the difference (D_{F}−D_{C}) is within the above range and the volume-average particle diameter D_{F} of the fluorescent toner particles is larger than the volume-average particle diameter D_{C} of the non-fluorescent toner particles, the fluorescent toner and the non-fluorescent toner have substantially the same charge retention. Therefore, the transfer failure of the multilayer toner image of the fluorescent toner image and the non-fluorescent toner image is less likely to occur, and a decrease in secondary transfer efficiency can be easily reduced.

The volume-average particle diameter D_{F} of the fluorescent toner particles is preferably 5.3 μm or more and 6.3 μm or less, more preferably 5.5 μm or more and 6.1 μm or less, still more preferably 5.7 μm or more and 5.9 μm or less.

When the volume-average particle diameter D_{F} of the fluorescent toner particles is within the above range, the charge retention of the fluorescent toner is likely to be moderately ensured. Therefore, the transfer failure of the multilayer toner image of the fluorescent toner image and the non-fluorescent toner image is less likely to occur, and a decrease in secondary transfer efficiency can be easily reduced.

The volume-average particle diameter of the toner particles is measured using a Coulter Multisizer II (manufactured by Beckman Coulter, Inc.) and an ISOTON-II (manufactured by Beckman Coulter, Inc.) as a liquid electrolyte.

In the measurement, 0.5 mg or more and 50 mg or less of a sample to be measured is added to 2 ml of a 5% aqueous solution of a surfactant (preferably, sodium alkylbenzenesulfonate) as a dispersant. This is added to 100 ml or more and 150 ml or less of the liquid electrolyte.

The liquid electrolyte in which the sample is suspended is subjected to a dispersion treatment for one minute using an ultrasonic disperser, and the particle size distribution of particles having a particle diameter in the range of 1 μm or more and 30 μm or less is measured by Coulter Multisizer II using an aperture having an aperture diameter of 50 μm. The number of particles to be sampled is 50000.

Cumulative distributions by volume and number are plotted from the smaller diameter side for particle size ranges (channels) divided based on the measured particle size distribution. The particle diameter at cumulative 50% is defined as the volume-average particle diameter D50v.

### Composition of Toner and Toner Particles

The fluorescent toner includes, for example, fluorescent toner particles containing a binder resin and an azomethine fluorescent colorant.

The non-fluorescent toner includes, for example, non-fluorescent toner particles that contain a binder resin and a non-fluorescent colorant but do not contain a fluorescent colorant.

The fluorescent toner particles and the non-fluorescent toner particles may contain a release agent, other additives, and the like.

The fluorescent toner particles may contain a fluorescent colorant other than the azomethine fluorescent colorant.

The fluorescent toner and the non-fluorescent toner may each contain an external additive that is externally added to the toner particles.

### Binder Resin

The binder resin is not particularly limited and may be appropriately selected in accordance with the intended purpose. Examples of the binder resin include vinyl-based resins including a homopolymer of a monomer, such as styrenes (e.g., styrene, p-chlorostyrene, and α-methylstyrene), (meth)acrylic acid esters (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (such as vinyl methyl ketone, vinyl ethyl ketone, vinyl isopropenyl ketone), and olefins (e.g., ethylene, propylene, butadiene), or a copolymer obtained by combining two or more kinds of monomers described above.

Examples of the resin include non-vinyl-based resins such as an epoxy resin, a polyester resin, a polyurethane resin, a polyamide resin, a cellulose resin, a polyether resin, and a modified rosin; mixtures of these non-vinyl-based resins with the vinyl-based resins; or graft polymers obtained by polymerizing a vinyl-based monomer in the coexistence of these resins.

These resins may be used alone or in combination of two or more.

These resins may be included as a binder resin. Alternatively, two or more of these resins may be included as binder resins or as a binder resin and (encapsulated) resin particles.

In particular, an amorphous resin and a crystalline resin are preferably applied as the binder resin.

Herein, the mass ratio of the crystalline resin to the amorphous resin (crystalline resin/amorphous resin) is preferably 1/99 or more and 50/50 or less, more preferably 2/98 or more and 30/70 or less, still more preferably 3/97 or more and 20/80 or less.

Here, the crystalline resin refers to a resin having a clear endothermic peak rather than a stepwise endothermic change in differential scanning calorimetry (DSC), and specifically refers to a resin whose half width of the endothermic peak measured at a rate of temperature increase of 10 (° C./min) is 10° C. or less. On the other hand, the amorphous resin refers to a resin that has a half width of higher than 10° C., demonstrates a stepwise endothermic change, or does not have a clearly recognizable endothermic peak.

Specifically, for example, the crystalline resin refers to a resin having a half width of an endothermic peak of 10° C. or less measured at a rate of temperature increase of 10° C./min, and the amorphous resin refers to a resin having a half width of higher than 10° C. or a resin not having a clearly recognizable endothermic peak.

### Amorphous Resin

Examples of the amorphous resin include known amorphous resins, such as an amorphous polyester resin, an amorphous vinyl resin (e.g., a styrene acrylic resin), an epoxy resin, a polycarbonate resin, and a polyurethane resin. Among these examples, an amorphous polyester resin and an amorphous vinyl resin (in particular, a styrene acrylic resin) are preferable, and an amorphous polyester resin is more preferable. A still more preferable form of the amorphous resin includes a combination of an amorphous polyester resin and a styrene acrylic resin.

### Amorphous Polyester Resin

Examples of the amorphous polyester resin include a modified amorphous polyester resin as well as an unmodified amorphous polyester resin.

The modified amorphous polyester resin refers to an amorphous polyester resin including a bonding group other than an ester bond; or an amorphous polyester resin containing resin components different from polyester that are bonded by a covalent bond, an ionic bond, or the like.

Examples of the modified amorphous polyester resin include a resin having a modified terminal that is obtained by reacting an active hydrogen compound with an amorphous polyester resin having a terminal into which a functional group such as an isocyanate group is introduced.

A more preferable, applicable form of the amorphous polyester resin includes an amorphous resin having an amorphous polyester resin segment and a styrene-acrylic resin segment.

For the amorphous polyester resin, hydrophilicity/hydrophobicity and compatibility may be controlled by subjecting a polyester chain to terminal modification and/or grafting.

Examples of the amorphous polyester resin include condensation polymers of a polyvalent carboxylic acid and a polyhydric alcohol. The amorphous polyester resin may be a commercially available product or a synthesized product.

Examples of the polyvalent carboxylic acid include aliphatic dicarboxylic acids (e.g., oxalic acid; malonic acid; maleic acid; fumaric acid; citraconic acid; itaconic acid; glutaconic acid; succinic acid; alkenyl succinic acids such as hexenyl succinic acid, octenyl succinic acid, dodecenyl succinic acid, and pentadecenyl succinic acid and anhydrides thereof, adipic acid; and sebacic acid), alicyclic dicarboxylic acids (e.g., cyclohexanedicarboxylic acid), aromatic dicarboxylic acids (e.g., terephthalic acid, isophthalic acid, o-phthalic acid, and naphthalenedicarboxylic acid), anhydrides thereof, and lower alkyl esters thereof (e.g., an alkyl ester having one or more and five or less carbon atoms). Among these, for example, aromatic dicarboxylic acids are preferable as the polyvalent carboxylic acid.

As the polyvalent carboxylic acid, a trivalent or higher carboxylic acid having a crosslinked structure or a branched structure may be used in combination with the dicarboxylic acid. Examples of the trivalent or higher carboxylic acid include trimellitic acid, pyromellitic acid, anhydrides thereof, and lower alkyl esters thereof (e.g., an alkyl ester having one or more and five or less carbon atoms).

The polyvalent carboxylic acids may be used alone or in combination of two or more.

Examples of the polyhydric alcohol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., an ethylene oxide adduct of bisphenol A and a propylene oxide adduct of bisphenol A). Among these examples, the polyhydric alcohol is preferably, for example, an aromatic diol or an alicyclic diol, more preferably an aromatic diol.

As the polyhydric alcohol, a trihydric or higher polyhydric alcohol having a crosslinked structure or a branched structure may be used in combination with a diol. Examples of the trihydric or higher polyhydric alcohol include glycerin, trimethylol propane, and pentaerythritol.

The polyhydric alcohols may be used alone or in combination of two or more.

The amorphous polyester resin is obtained by a well-known production method. Specifically, for example, the amorphous polyester resin is obtained by a method of causing a reaction at a polymerization temperature adjusted to fall within the range of 180° C. or more and 230° C. or less, and if necessary, under reduced pressure in the reaction system, while removing water and alcohols generated during condensation.

The proportion of the amorphous polyester resin to the total amount of resin is preferably 60% by mass or more and 98% by mass or less, more preferably 65% by mass or more and 95% by mass or less, still more preferably 70% by mass or more and 90% by mass or less.

### Styrene Acrylic Resin

The styrene acrylic resin is a copolymer obtained by copolymerizing at least a styrenic monomer (a monomer having a styrene skeleton) and a (meth)acrylic monomer (a monomer having a (meth)acrylic group, preferably a monomer having a (meth)acryloxy group). Examples of the styrene acrylic resin include a copolymer of a monomer of styrenes with a monomer of (meth)acrylic acid esters.

The acrylic resin portion of the styrene acrylic resin is an acrylic monomer, a methacrylic monomer, or a partial structure obtained by polymerizing both an acrylic monomer and a methacrylic monomer. The term “(meth)acryl” encompasses both “acryl” and “methacryl”.

Examples of the styrenic monomer include styrene, α-methylstyrene, m-chlorostyrene, p-chlorostyrene, p-fluorostyrene, p-methoxystyrene, m-tert-butoxystyrene, p-tert-butoxystyrene, p-vinylbenzoic acid, and p-methyl-α-methylstyrene. The styrenic monomers may be used alone or in combination of two or more.

Examples of the (meth)acrylic monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, 2-hydroxyethyl (meth)acrylate, hydroxypropyl (meth)acrylate, and 4-hydroxybutyl (meth)acrylate. The (meth)acrylic monomers may be used alone or in combination of two or more.

The polymerization ratio of the styrenic monomer to the (meth)acrylic monomer preferably satisfies, on a mass basis, styrenic monomer:(meth)acrylic monomer=70:30 to 95:5.

The styrene acrylic resin may have a crosslinked structure. The styrene acrylic resin having a crosslinked structure can be produced by, for example, copolymerizing a styrenic monomer, a (meth)acrylic monomer, and a crosslinkable monomer. The crosslinkable monomer is preferably, but not particularly limited to, a bifunctional or higher (meth)acrylate compound.

The method of producing the styrene acrylic resin is not particularly limited. Examples of an applicable method include solution polymerization, precipitation polymerization, suspension polymerization, bulk polymerization, and emulsion polymerization. A known operation (e.g., a batch operation, a semi-continuous operation, or a continuous operation) is applied to the polymerization reaction.

The proportion of the styrene acrylic resin to the total amount of resin is preferably 60% by mass or more and 98% by mass or less, more preferably 65% by mass or more and 95% by mass or less, still more preferably 70% by mass or more and 90% by mass or less.

### Polyester Resin Containing Modified Group Such as Isocyanate Group, Epoxy Group, or Urea Group (Hereinafter Also Referred to as “Modified Polyester Resin”)

Examples of the modified polyester resin include a resin obtained by reacting a polyester resin having an active hydrogen group with a compound having a modifying group such as an isocyanate group, an epoxy group, or a urea group; and a resin obtained by reacting a compound having an active hydrogen group, a polyester resin having an active hydrogen group, and a compound having a modifying group such as an isocyanate group or an epoxy group.

The active hydrogen-containing group includes at least one group selected from a hydroxyl group, a mercapto group, an amino group, a carboxyl group, a phosphate group, a sulfonate group, and a sulfate group, all of which can be easily combined with isocyanate compounds and epoxy compounds. The active hydrogen-containing group may include two or more of the above groups.

The polyester resin having an active hydrogen group is obtained by, for example, subjecting a polyvalent carboxylic acid and a polyhydric alcohol to polycondensation. As the polyvalent carboxylic acid and the polyhydric alcohol, for example, one of those exemplified above may be used alone, or two or more thereof may be used in combination.

The compound containing an active hydrogen group is not particularly limited as long as the compound has an active hydrogen group, and can be appropriately selected in accordance with the intended purpose.

When an isocyanate group is contained as the modifying group, amines may be used as the active hydrogen group-containing compound.

The amines are not particularly limited and may be appropriately selected in accordance with the intended purpose. Examples of the amines include diamines, polyamines having three or more amino groups, amino alcohols, amino mercaptans, amino acids, and these amines with a blocked amino group. Specific examples of the amines include aromatic diamines, aliphatic diamines, ethylenetriamine, triethylenetetramine, ethanolamine, hydroxyethylaniline, aminoethyl mercaptan, aminopropyl mercaptan, aminopropionic acid, aminocaproic acid, ketimine compounds obtained from any of these amines (e.g., diamines, polyamines having three or more amino groups, amino alcohols, amino mercaptans, amino acids) and ketones (e.g., acetone, methyl ethyl ketone, methyl isobutyl ketone), and oxazoline compounds.

Examples of the compound having an isocyanate group include aliphatic polyisocyanates (e.g., tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate); alicyclic polyisocyanates (e.g., isophorone diisocyanate and cyclohexylmethane diisocyanate); aromatic diisocyanates (e.g., tolylene diisocyanate, diphenylmethane diisocyanate, 1,5-naphthylene diisocyanate, diphenylene-4,4′-diisocyanate, 4,4′-diisocyanato-3,3′-dimethylbiphenyl, 3-methyldiphenylmethane-4,4′-diisocyanate, and diphenyl ether-4,4′-diisocyanate); aromatic aliphatic diisocyanates (e.g., α,α,α′,α′-tetramethylxylylene diisocyanate); isocyanurates (e.g., tris-isocyanatoalkyl-isocyanurate and triisocyanatocycloalkyl-isocyanurates); phenol derivatives of these compounds; and these compounds blocked with an oxime, a caprolactam, or the like. These compounds may be used alone or in combination of two or more.

No limitation is placed on the method of synthesizing a resin obtained by reacting a polyester resin having an active hydrogen group with a compound having a modifying group such as an isocyanate group, an epoxy group, or a urea group, and the method of synthesizing a resin obtained by reacting a compound having an active hydrogen group with a polyester resin having an active hydrogen group and with a compound having a modifying group such as an isocyanate group or an epoxy group. In the case of a resin obtained by reacting a polyester resin having an active hydrogen group with a compound having a modifying group such as an isocyanate group or an epoxy group, examples of the method include a method of synthesizing the resin by reacting a hydroxyl group-containing polyester resin obtained by the above-described well-known production method with a compound having a modifying group; and a method of synthesizing the resin by, for example, a chain extension reaction and/or a crosslinking reaction. Since the active hydrogen group is included, those having an active hydrogen group serve as a chain extender and/or a crosslinker in the chain extension reaction and/or the crosslinking reaction. The chain extension reaction and/or the crosslinking reaction may be terminated, if necessary, with a reaction terminator (e.g., diethylamine; dibutylamine; butylamine; laurylamine; and compounds obtained by blocking monoamine, such as a ketimine compound).

### Amorphous Resin Having Polyester Resin Segment and Styrene Acrylic Resin Segment (Hereinafter Also Referred to as “Hybrid Polyester Resin”)

The hybrid polyester resin is a polyester resin in which a polyester resin segment and a styrene acrylic resin segment are chemically bonded to each other.

Examples of the hybrid polyester resin include a resin having a main chain including a polyester resin and a side chain including a styrene acrylic resin chemically bonded to the main chain; a resin having a main chain including a styrene acrylic resin and a side chain including a polyester resin chemically bonded to the main chain; a resin having a main chain produced by chemically bonding a polyester resin and a styrene acrylic resin; and a resin having a main chain produced by chemically bonding a polyester resin and a styrene acrylic resin and at least one of a side chain including a polyester resin chemically bonded to the main chain and a side chain including a styrene acrylic resin chemically bonded to the main chain.

The polyester resin and the styrene acrylic resin of each segment are as described above, and the description thereof is omitted.

The proportion of the total amount of the polyester resin segment and the styrene acrylic resin segment to the total amount of the hybrid polyester resin is preferably 80% by mass or more, more preferably 90% by mass or more, still more preferably 95% by mass or more, yet still more preferably 100% by mass.

In the hybrid polyester resin, the proportion of the styrene acrylic resin segment to the total amount of the polyester resin segment and the styrene acrylic resin segment is preferably 20% by mass or more and 90% by mass or less, more preferably 25% by mass or more and 80% by mass or less, still more preferably 30% by mass or more and 70% by mass or less.

The hybrid polyester resin is preferably produced by any one of the following methods (i) to (iii).
(i) a polyester resin segment is produced by condensation polymerization of a polyhydric alcohol and a polyvalent carboxylic acid, and then monomers constituting a styrene acrylic resin segment are subjected to addition polymerization with the polyester resin segment;
(ii) a styrene acrylic resin segment is produced by addition polymerization of addition-polymerizable monomers, and then a polyhydric alcohol and a polyvalent carboxylic acid are subjected to condensation polymerization with the styrene acrylic resin segment; and
(iii) condensation polymerization of a polyhydric alcohol and a polyvalent carboxylic acid and addition polymerization of addition-polymerizable monomers are carried out in parallel.

The proportion of the hybrid polyester resin to the total amount of the binder resin is preferably 60% by mass or more and 98% by mass or less, more preferably 65% by mass or more and 95% by mass or less, still more preferably 70% by mass or more and 90% by mass or less.

### Glass Transition Temperature of Amorphous Resin

The glass transition temperature (Tg) of the amorphous resin is preferably 50° C. or more and 80° C. or less, more preferably 50° C. or more and 65° C. or less.

Note that the glass transition temperature is determined from a differential scanning calorimetry (DSC) curve obtained by DSC. More specifically, the glass transition temperature is determined conforming to the “extrapolated glass transition starting temperature” described in the method of determining a glass transition temperature in JIS K 7121-1987 “Testing Methods for Transition Temperatures of Plastics”.

### Molecular Weight of Amorphous Resin

The amorphous resin preferably has a weight-average molecular weight (Mw) of 3000 or more and 1000000 or less, more preferably 7000 or more and 500000 or less.

The amorphous resin preferably has a number-average molecular weight (Mn) of 2000 or more and 100000 or less.

The amorphous resin preferably has a molecular weight distribution Mw/Mn of 1.5 or more and 100 or less, more preferably 2 or more and 60 or less.

Note that the weight-average molecular weight and the number-average molecular weight are measured by gel permeation chromatography (GPC). The molecular weight measurement by GPC is performed using an HLC-8320GPC, which is a GPC manufactured by Tosoh Corporation, as a measurement device; a TSKgel SuperHM-M (15 cm), which is a column manufactured by Tosoh Corporation; and a tetrahydrofuran (THF) solvent. The weight-average molecular weight and the number-average molecular weight are calculated from the measurement results by using a molecular weight calibration curve plotted using a monodisperse polystyrene standard sample.

### Crystalline Resin

Examples of the crystalline resin include a crystalline polyester resin.

### Crystalline Polyester Resin

Examples of the crystalline polyester resin include polycondensates of a polyvalent carboxylic acid and a polyhydric alcohol. As the crystalline polyester resin, a commercially available product may be used, or a synthesized product may be used.

Here, since the crystalline polyester resin easily forms a crystal structure, a polycondensate using a polymerizable monomer having linear aliphatics is more preferable than that using a polymerizable monomer having aromatics. From the viewpoint of compatibility with the amorphous resin, a polycondensate using a polymerizable monomer having aromatics, the above-described modified polyester, a hybrid resin, or the like may be used.

The crystalline polyester resins may be used alone or in combination of two or more.

Examples of the polyvalent carboxylic acid include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., phthalic acid, isophthalic acid, terephthalic acid, and naphthalene-2,6-dicarboxylic acid), anhydrides thereof, and lower alkyl esters (e.g., an alkyl ester having one or more and five or less carbon atoms) thereof.

As the polyvalent carboxylic acid, a trivalent or higher carboxylic acid having a crosslinked structure or a branched structure may be used in combination with the dicarboxylic acid. Examples of the trivalent or higher carboxylic acid include trimellitic acid, pyromellitic acid, anhydrides thereof, and lower alkyl esters thereof (e.g., an alkyl ester having one or more and five or less carbon atoms).

As the polyvalent carboxylic acid, a dicarboxylic acid having a sulfonate group or a dicarboxylic acid having an ethylenic double bond may be used in combination with the dicarboxylic acid.

The polyvalent carboxylic acids may be used alone or in combination of two or more.

Examples of the polyhydric alcohol include aliphatic diols (e.g., a linear aliphatic diol having two or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among these examples, 1,6-hexanediol, 1,8-octanediol, 1,9-nonanediol, and 1,10-decanediol are preferable as the aliphatic diol.

As the polyhydric alcohol, a trihydric or higher alcohol having a crosslinked structure or a branched structure may be used in combination with the diol. Examples of the trihydric or higher alcohol include glycerin, trimethylol ethane, trimethylol propane, and pentaerythritol.

The polyhydric alcohols may be used alone or in combination of two or more.

Here, the polyhydric alcohol preferably has an aliphatic diol content of 80 mol % or more, preferably 90 mol % or more.

The melting temperature of the crystalline polyester resin is preferably 50° C. or more and 100° C. or less, more preferably 55° C. or more and 90° C. or less, still more preferably 60° C. or more and 85° C. or less.

Note that the melting temperature is determined from a differential scanning calorimetry (DSC) curve obtained by DSC, conforming to the “melting peak temperature” described in the method of determining a melting temperature in JIS K 7121-1987 “Testing Methods for Transition Temperatures of Plastics”.

The crystalline polyester resin preferably has a weight-average molecular weight (Mw) of 6,000 or more and 50,000 or less.

The crystalline polyester resin is obtained by, for example, a well-known production method as in the amorphous polyester resin.

The content of the binder resin in the entire toner particles is, for example, preferably 40% by mass or more and 95% by mass or less, more preferably 50% by mass or more and 90% by mass or less, still more preferably 60% by mass or more and 90% by mass or less.

When the toner particles contain a binder resin as the resin particles, the toner particles may contain crosslinked resin particles as the resin particles. The crosslinkers for obtaining the crosslinked resin particles may be used alone or in combination of two or more.

The average primary particle diameter of the resin particles is preferably 10 nm or more and 500 nm or less, more preferably 20 nm or more and 300 nm or less, still more preferably 30 nm or more and 250 nm or less.

The average primary particle diameter of the resin particles is a value measured using a transmission electron microscope (TEM).

As the transmission electron microscope, for example, S4800 manufactured by Hitachi High-Tech Corporation can be used.

Specifically, a method of measuring the average primary particle diameter of resin particles is as follows.

The toner particles are cut into a piece having a thickness of about 0.1 μm with a microtome. The cross-section of the toner particle is photographed at a magnification of 10000× using the transmission electron microscope, and the equivalent circle diameter is calculated from the cross-sectional area of each of the 100 resin particles dispersed in the toner particles. Then, the arithmetic average value of the equivalent circle diameters is defined as an average primary particle diameter.

The content of the resin particles in the toner particles is preferably 0% by mass or more and 30% by mass or less, more preferably 1% by mass or more and 25% by mass or less, still more preferably 3% by mass or more and 20% by mass or less.

### Azomethine Fluorescent Colorant

The azomethine fluorescent colorant is an organic pigment having an azomethine structure.

Examples of the azomethine fluorescent colorant include organic pigments having an azomethine structure represented by —R¹C═N— (R¹ represents a hydrogen atom or a monovalent substituent).

Examples of the azomethine fluorescent colorant also include organic pigments having a bisazomethine structure represented by —R¹C═N—N═CR²— (R¹ and R² each independently represent a hydrogen atom or a monovalent substituent) in the molecular structure.

The fluorescent colorant refers to an organic pigment that emits light due to external light energy.

The non-fluorescent colorant refers to an organic pigment that does not emit light due to external light energy.

In general, fluorescent pigments exhibit a color due to both reflected and emitted light, whereas non-fluorescent pigments exhibit a color due to reflected light alone.

Examples of the azomethine fluorescent colorant include the following azomethine compounds (1) to (3).

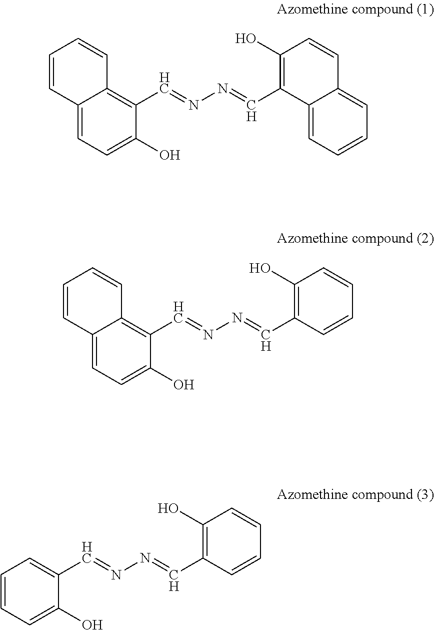 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The azomethine compound (1) has an emission peak wavelength of 520 nm.

The azomethine compound (2) has an emission peak wavelength of 510 nm.

The azomethine compound (3) has an emission peak wavelength of 520 nm.

Here, the emission peak wavelength is measured, for example, using a UV-3600 (spectrophotometer manufactured by Shimadzu Corporation) according to the measurement method specified by Japanese Industrial Standards (JIS K 5101-3-3).

Preferred examples of the azomethine fluorescent colorant also include derivatives of azomethine compounds, and more preferred examples of the azomethine fluorescent colorant include boron difluoride derivatives of azomethine compounds.

Examples of the boron difluoride derivative of the azomethine compound include the following compound.

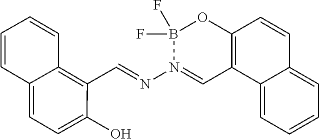

The azomethine fluorescent colorant is preferably at least one selected from the group consisting of the azomethine compound (1), the azomethine compound (2), the azomethine compound (3), and boron difluoride derivatives of these azomethine compounds.

As the fluorescent colorant, C.I. Pigment Yellow 101 or boron difluoride derivatives of C.I. Pigment Yellow 101 are preferable, and C.I. Pigment Yellow 101 represented by the azomethine compound (1) is more preferable.

The content of the azomethine fluorescent colorant in the fluorescent toner particles is preferably 5.0% by mass or more and 11.0% by mass or less, more preferably 6.0% by mass or more and 10% by mass or less, still more preferably 7.0% by mass or more and 9.0% by mass or less.

When the content of the azomethine fluorescent colorant is within the above range, an image having an intended chroma is easily obtained.

The content of the fluorescent pigment contained in the toner particles can be determined as follows.

The toner to be measured is dispersed in water containing a surfactant, subjected to ultrasonic treatment, and then dried to obtain toner particles from which the external additives have been removed. One gram of the obtained toner particles is weighed, 20 ml of tetrahydrofuran (THF) is added, and the mixture is subjected to ultrasonic treatment for 15 minutes. Subsequently, 60 ml of acetonitrile is then added to the resulting dispersion liquid of the toner particles, the mixture is left to stand for 60 minutes, and then centrifugal separation is performed under conditions of 20,000 rpm, 4° C., and 30 minutes to collect the supernatant. The supernatant is filtered through a 0.2 μm filter, and 0.1 ml of octylphenol is added thereto to prepare a measurement sample.

The obtained measurement sample is analyzed with a liquid chromatograph mass spectrometer (LCMS-IT-TOF: manufactured by Shimadzu Corporation). From the obtained peak intensity and waveform separation, the amount of fluorescent pigment contained in the flowing toner water is determined.

### Other Fluorescent Colorants

Examples of other fluorescent pigments include isoindolinone compounds, xanthene compounds (including rhodamine compounds, fluorescein compounds, and eosin compounds), naphthalene compounds, and triarylmethane compounds.

### Non-Fluorescent Colorant

The non-fluorescent colorant is selected in accordance with the intended color of the toner.

Examples of the non-fluorescent colorant include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Dupont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; various inorganic pigments such as titanium compounds, silica, aluminum, and mica; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye. The non-fluorescent colorant is not limited to a substance that absorbs light in the visible light region. The non-fluorescent colorant may be, for example, a substance that absorbs light in the near-infrared region or a pearlescent colorant.

The non-fluorescent colorants may be used alone or in combination of two or more.

The non-fluorescent colorant may be a colorant whose surface is treated as needed, or may be used together with a dispersant. In addition, a plurality of colorants may be used in combination.

The content of the non-fluorescent colorant in the entire non-fluorescent toner particles is, for example, preferably 1% by mass or more and 30% by mass or less, more preferably 3% by mass or more and 15% by mass or less.

The non-fluorescent colorant may be used in a state of being contained in a resin or after being composited, if necessary. Such a resin is not particularly limited, but the above-described resin or a resin having a similar structure is preferably used from the viewpoint of compatibility.

### Release Agent

Examples of the release agent include hydrocarbon-based waxes; natural waxes such as carnauba wax, rice wax, and candelilla wax; synthetic or mineral/petroleum waxes such as montan wax; and ester-based waxes such as a fatty acid ester and a montanic acid ester. The release agent is not particularly limited and can be appropriately selected in accordance with the intended purpose. Hydrocarbon-based waxes and ester-based waxes are preferable as the release agent.

The release agents may be used alone or in combination of two or more.

The melting temperature of the release agent is preferably 50° C. or more and 110° C. or less, more preferably 60° C. or more and 100° C. or less.

Note that the melting temperature is determined from a differential scanning calorimetry (DSC) curve obtained by DSC, conforming to the “melting peak temperature” described in the method of determining a melting temperature in JIS K 7121-1987 “Testing Methods for Transition Temperatures of Plastics”.

The content of the release agent in the entire toner particles is, for example, preferably 1% by mass or more and 20% by mass or less, more preferably 4% by mass or more and 15% by mass or less.

The release agent may be used in a state of being contained in the resin or after being composited, if necessary. Such a resin is not particularly limited, but the above-described resin or a resin having a similar structure is preferably used from the viewpoint of compatibility.

### Other Additives

Examples of other additives include well-known additives such as a magnetic material, a charge control agent, and inorganic powder. These additives are preferably contained in the toner particles as internal additives.

The charge control agent is not particularly limited and may be appropriately selected in accordance with the intended purpose. Examples of the charge control agent include nigrosine dyes, triphenylmethane dyes, chromium-containing metal complex dyes, molybdic acid chelate pigments, rhodamine dyes, alkoxy amines, quaternary ammonium salts (including a fluorine-modified quaternary ammonium salt), alkylamides, phosphorus or phosphorus compounds, tungsten or tungsten compounds, fluorine-based activators, salicylic acid metal salts, and metal salts of salicylic acid derivatives. In a case of being used as a negatively chargeable toner, azo complex salt dyes of chromium, iron or the like; complex compounds produced from salicylic acid and chromium, zinc, aluminum, boron or the like; or charge control resins can be used as the charge control agent. The content of the charge control agent is not particularly limited and can be appropriately selected in accordance with the intended purpose. The content thereof is preferably 0.1 parts by mass or more and 10 parts by mass or less, more preferably 0.2 parts by mass or more and 5 parts by mass or less relative to 100 parts by mass of the toner.

Examples of the inorganic powder include a layered inorganic powder and a layered inorganic mineral obtained by modifying at least part of interlayer ions contained in the layered inorganic mineral with an organic ion, such as montmorillonite, bentonite, hectorite, attapulgite, sepiolite, and mixtures thereof. Among these examples, organic-modified montmorillonite or bentonite is preferable as the inorganic powder because they do not affect the toner properties, can be easily adjusted in terms of viscosity, and can be effective with a small addition amount. The inorganic powder may be used when a toner is produced by the ester extension polymerization described later. The content of the inorganic powder in the toner particles is preferably 0.2% by mass or more and 2.0% by mass or less, more preferably 0.7% by mass or more and 1.5% by mass or less.

### Properties of Toner Particles

The toner particles may be toner particles having a single-layer structure, or may be toner particles having a so-called core-shell structure including a core (core particle) and a coating layer (shell layer) with which the core is coated.

The toner particles having a core-shell structure may each be composed of, for example, a core containing a resin and, if necessary, a colorant, a release agent, and other additives, and a coating layer containing a resin. The coating layer may have a multilayer structure.

Depending on the core and each layer in the coating layer, the kind of resin and the physical properties such as glass transition temperature (Tg) and SP value may be changed, or the presence or absence of the type of the colorant and the release agent may be changed.

Here, a coating layer may be formed when the toner particles are produced, or a step of forming a coating layer after completion of toner particle production may be provided.

For example, a plurality of production methods may be used, such as a method in which toner particles are produced by a kneading and pulverizing method described later and then a coating layer is formed by a wet production method. Alternatively, the coating layer may be formed by causing a polymer component and/or a crosslinking component to adhere to the toner particles and then performing a polymerization reaction and/or a crosslinking reaction. The coating layer may be formed by depositing an organosilicon compound/polymer, an organotitanium compound/polymer, or the like on the surfaces of the toner particles by a sol-gel production method or the like.

The coating layer may be cured or hardened by being subjected to a surface hardening treatment with hot air or a dry mill; an amine treatment; or a surface treatment using a compound having an isocyanate group or the like, a thermosetting resin, a thermoplastic resin, or the like.

The coating layer may contain an organic component and/or an inorganic component, and may contain the resin described above or an external additive described later.

The coverage of the core with the coating layer may be adjusted depending on the intended purpose. The coating layer may cover part or all of the surface of the core depending on the intended purpose.

The volume-average particle diameter (D50v) of the toner particles is preferably 2 μm or more and 10 μm or less, more preferably 4 μm or more and 8 μm or less.

The average particle diameters and particle size distribution indices of the toner particles are measured using a Coulter Multisizer II (manufactured by Beckman Coulter, Inc.) and an ISOTON-II (manufactured by Beckman Coulter, Inc.) as a liquid electrolyte.

In the measurement, 0.5 mg or more and 50 mg or less of a sample to be measured is added to 2 ml of a 5% aqueous solution of a surfactant (preferably, sodium alkylbenzene sulfonate) as a dispersant. This is added to 100 ml or more and 150 ml or less of the liquid electrolyte.

The liquid electrolyte in which the sample is suspended is subjected to a dispersion treatment for one minute using an ultrasonic disperser, and the particle size distribution of particles having a particle diameter in the range of 1 μm or more and 30 μm or less is measured by a Coulter Multisizer II using an aperture having an aperture diameter of 50 μm. The number of particles to be sampled is 50000.

Cumulative distributions by volume and number are plotted from the smaller diameter side for particle size ranges (channels) divided based on the measured particle size distribution. Particle diameters at cumulative 16% are defined as the volume particle diameter D16v and the number particle diameter D16p, particle diameters at cumulative 50% are defined as the volume-average particle diameter D50v and the number-average particle diameter D50p, and particle diameters at cumulative 84% are defined as the volume particle diameter D84v and the number particle diameter D84p.

The volume particle size distribution index (GSDv) is calculated as (D84v/D16v)^{1/2}, and the number particle size distribution index (GSDp) is calculated as (D84p/D16p)^{1/2}.

The average circularity of the toner particles is preferably 0.90 or more and 1.00 or less, and more preferably 0.92 or more and 0.98 or less.

The average circularity of the toner particles is determined from (Equivalent circle perimeter)/(Perimeter), or (Perimeter of a circle having the same projected area as the toner particle image)/(Perimeter of the projected image of the toner particle). Specifically, the average circularity of the toner particles is a value measured by the following method.

First, toner particles to be measured are collected by suction and a flat flow is formed. Then, a particle image is captured as a still image by instantaneously emitting strobe light. The average circularity is determined by using a flow particle image analyzer (Parshe Analyzer PAS, manufactured by HOSOKAWA MICRON Corporation) that can perform image analysis of the particle image. The number of samples for obtaining the average circularity is 10000.

When the toner contains an external additive, the toner (developer) to be measured is dispersed in water containing a surfactant, and then an ultrasonic treatment is performed to obtain toner particles from which the external additive has been removed.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO SiO₂, K₂O·(TiO₂)ₙ, Al₂O₃·2SiO₂, CaCO₃, MgCO₃, BaSO₄, and MgSO₄.

The surfaces of the inorganic particles as an external additive are preferably hydrophobized. Hydrophobization is performed by, for example, immersing the inorganic particles in a hydrophobizing agent. The hydrophobizing agent is not particularly limited, and examples thereof include a silane-based coupling agent, silicone oil, a titanate-based coupling agent, an aluminum-based coupling agent, and other silicon compounds. The hydrophobizing agents may be used alone or in combination of two or more.

The amount of the hydrophobizing agent is usually, for example, 1 part by mass or more and 30 parts by mass or less relative to 100 parts by mass of the inorganic particles.

Examples of the external additive also include resin particles (resin particles of polystyrene, polymethyl methacrylate (PMMA), and melamine resin); and cleaning lubricants (metal salts of higher fatty acids represented by zinc stearate, and higher alcohols).

The external addition amount of the external additive in the toner particles is, for example, preferably 0.01% by mass or more and 10% by mass or less, more preferably 0.01% by mass or more and 8.0% by mass or less.

### Method of Producing Toner

Next, a method of producing the toner according to the present exemplary embodiment will be described.

The toner according to the present exemplary embodiment is obtained by producing toner particles and then externally adding an external additive to the toner particles.

Toner particles may be produced by any of dry production methods (e.g., a kneading and pulverizing method) or wet production methods (e.g., an aggregation-coalescence method, a suspension polymerization method, a dissolution suspension method, and an ester extension polymerization method). The production method of toner particles is not particularly limited to these methods, and a well-known method is employed.

In the kneading and pulverizing method, the binder resin and the colorant are melt-kneaded together with, if necessary, a charge control agent, a release agent, and the like, cooled, then finely pulverized, and further classified to produce toner particles. The kneaded material may be pulverized using a pulverizer such as a jet mill, a turbo mill, a kryptron, or an inomizer (pulverization step), and the pulverized material may be classified using a classifier such as an elbow jet, a turboplex, or a dispersion separator.

In the aggregation-coalescence method, toner particles are produced through a step of preparing a resin particle dispersion liquid in which resin particles serving as a binder resin are dispersed and a colorant dispersion liquid in which a colorant is dispersed (resin particle dispersion liquid preparation step), a step of aggregating the resin particles, the colorant, and optionally other particles in a mixed dispersion liquid of the resin particle dispersion liquid and the colorant dispersion liquid (if necessary, in a dispersion liquid obtained after mixing with another particle dispersion liquid) to form aggregated particles (aggregated particle formation step), and a step of heating the aggregated particle dispersion liquid in which the aggregated particles are dispersed to fuse and coalesce the aggregated particles, thereby forming toner particles (fusion and coalescence step).

In the dissolution suspension method, a binder resin or a resin precursor and a colorant are dissolved in an organic solvent or the like and dispersed or emulsified in an aqueous medium to produce toner particles.

In the ester extension polymerization method, an oil-phase composition containing a binder resin precursor having a reactive functional group and a colorant is emulsified or dispersed in an aqueous medium containing resin fine particles in a dissolution suspension method, and an active hydrogen group-containing compound is reacted with the resin precursor in the aqueous medium to produce toner particles.

In any of the production methods, a release agent, other additives (e.g., a charge control agent), and the like may be used as needed.

In the wet production method, the toner particles formed in the solution undergo a known washing step, solid-liquid separation step, and drying step to obtain dried toner particles.

In the washing step, sufficient displacement washing with ion-exchanged water is preferably performed from the viewpoint of chargeability. The solid-liquid separation step is not particularly limited, but suction filtration, pressure filtration, or the like is preferably performed from the viewpoint of productivity. The drying step is not particularly limited, but freeze drying, flash drying, fluidized drying, vibratory fluidized drying, or the like is preferably performed from the viewpoint of productivity.

The toner according to the present exemplary embodiment is produced, for example, by adding and mixing an external additive to the obtained dried toner particles. The mixing may be performed using, for example, a V-blender, a Henschel mixer, or a Lödige mixer, and the mixing may be performed at one time or may be performed a plurality of times by stepwise adding external additives. Further, if necessary, coarse particles of the toner may be removed by using a vibratory sieving machine, a wind power sieving machine, or the like.

### Electrostatic Charge Image Developer Set

The electrostatic charge image developer set according to the present exemplary embodiment includes a first electrostatic charge image developer containing the fluorescent toner in the electrostatic charge image developing toner set according to the present exemplary embodiment and a second electrostatic charge image developer containing the non-fluorescent toner in the electrostatic charge image developing toner set according to the present exemplary embodiment.

Each of the first electrostatic charge image developer and the second electrostatic charge image developer may be a single-component developer containing only a toner or a two-component developer containing a toner and a carrier in a mixed manner.

The carrier is not particularly limited, and examples thereof include known carriers. Examples of the carrier include coated carriers in which the surface of a core material including magnetic powder is coated with a coating resin; magnetic powder-dispersed carriers in which magnetic powder is dispersed and blended in a matrix resin; and resin-impregnated carriers in which porous magnetic powder is impregnated with a resin.

Note that the magnetic powder-dispersed carrier and the resin-impregnated carrier may be a carrier in which the constituent particle of the carrier is used as a core material, and the core material is coated with a coating resin.

Examples of the magnetic powder include powder of magnetic metals such as iron, nickel, and cobalt; and powder of magnetic oxides such as ferrite and magnetite. In particular, the powder of magnetite or ferrite is preferred. The magnetic powder can also be used in the form of particles dispersed in a resin.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic ester copolymers, straight silicone resins having an organosiloxane bond or modified products thereof, fluororesins, polyesters, polycarbonates, phenolic resins, and epoxy resins.

Note that the coating resin and the matrix resin may contain other additives such as conductive particles.

Examples of the conductive particles include particles of metals such as gold, silver, and copper; carbon black; titanium oxide; zinc oxide; tin oxide; barium sulfate; aluminum borate; and potassium titanate.

Examples of the other additives include inorganic particles; metal oxide particles such as silica, titanium oxide, zinc oxide, and tin oxide; metal compound particles such as barium sulfate, aluminum borate, and potassium titanate; and metal particles such as gold, silver, and copper.

Here, examples of the method of coating the surface of the core material with the coating resin include a method of performing coating with a coating layer forming solution in which the coating resin and, if necessary, various additives are dissolved in an appropriate solvent. The solvent is not particularly limited. It is sufficient that the solvent be selected in consideration of the coating resin to be used, coating suitability, and the like.

Specific examples of the resin coating method include an immersion method of immersing the core material in the coating layer forming solution, a spray method of spraying the coating layer forming solution onto the surface of the core material, a fluidized bed method of spraying the coating layer forming solution while floating the core material by flowing air, and a kneader coater method of mixing the core material of the carrier and the coating layer forming solution in a kneader coater and removing the solvent.

The mixing ratio (mass ratio) between the toner and the carrier in the two-component developer preferably satisfies toner:carrier=1:100 to 30:100, more preferably 3:100 to 20:100.

### Image Forming Apparatus/Image Forming Method

The image forming apparatus/image forming method according to the present exemplary embodiment will be described.

The image forming apparatus according to the present exemplary embodiment includes a first image forming unit that includes a first developing device accommodating a first electrostatic charge image developer in the electrostatic charge image developer set according to the present exemplary embodiment and that forms a first image with the first electrostatic charge image developer, a second image forming unit that includes a second developing device accommodating a second electrostatic charge image developer in the electrostatic charge image developer set according to the present exemplary embodiment and that forms a second image with the second electrostatic charge image developer, a transfer device that transfers the first image and the second image onto a recording medium, and a fixing device that fixes the first image and the second image onto the recording medium.

The image forming apparatus according to the present exemplary embodiment may include, as the first or second image forming unit, an image holding member, a charging device that charges the surface of the image holding member, an electrostatic charge image forming device that forms an electrostatic charge image on the charged surface of the image holding member, and a developing device that develops, with an electrostatic charge image developer, the electrostatic charge image formed on the surface of the image holding member into a toner image.

The image forming apparatus according to the present exemplary embodiment may include an image holding member, a charging device that charges the surface of the image holding member, an electrostatic charge image forming device that forms an electrostatic charge image on the charged surface of the image holding member, and, as the first and second image forming units, the first and second developing devices that develop the electrostatic charge image formed on the surface of the image holding member with an electrostatic charge image developer into a toner image.

In the image forming apparatus according to the present exemplary embodiment, an image forming method (image forming method according to the present exemplary embodiment) is performed that includes a first image forming step of forming a first image with the first electrostatic charge image developer in the electrostatic charge image developing toner set according to the present exemplary embodiment, a second image forming step of forming a second image with a second electrostatic charge image developer in the electrostatic charge image developing toner set according to the exemplary embodiment, a transfer step of transferring the first image and the second image onto a recording medium, and a fixing step of fixing the first image and the second image onto the recording medium.

As the image forming apparatus according to the present exemplary embodiment, known image forming apparatuses are applied, such as a direct transfer type apparatus which directly transfers a toner image (a fluorescent image and a non-fluorescent image in the present exemplary embodiment) formed on a surface of an image holding member to a recording medium; an intermediate transfer type apparatus which primarily transfers a toner image formed on the surface of an image holding member to a surface of an intermediate transfer member and secondarily transfers the toner image transferred onto the surface of the intermediate transfer member onto a surface of a recording medium; an apparatus including a cleaning unit that cleans the surface of the image holding member after transfer of the toner image and before charging; and an apparatus including a charge-erasing unit that irradiates the surface of the image holding member with charge-erasing light after transfer of the toner image and before charging.

In the case of the intermediate transfer type apparatus, for example, the transfer device includes an intermediate transfer member having a surface onto which a toner image is transferred; a primary transfer device that primarily transfers the toner image formed on the surface of an image holding member onto the surface of the intermediate transfer member; and a secondary transfer device that secondarily transfers the toner image transferred onto the surface of the intermediate transfer member onto the surface of the recording medium.

Note that, in the image forming apparatus according to the present exemplary embodiment, for example, a portion including the developing device may have a cartridge structure (process cartridge) that is attachable to and detachable from the image forming apparatus. As the process cartridge, for example, a process cartridge including a developing device that accommodates each electrostatic charge image developer in the electrostatic charge image developer set according to the present exemplary embodiment is suitably used.

Specifically, as the process cartridge, a process cartridge is used that includes a first developing device accommodating a first electrostatic charge image developer in the electrostatic charge image developer set according to the present exemplary embodiment and a second developing device accommodating a second electrostatic charge image developer in the electrostatic charge image developer set according to the present exemplary embodiment and that is detachably attachable to the image forming apparatus.

Hereinafter, an example of the image forming apparatus according to the present exemplary embodiment will be described, but the present disclosure is not limited thereto. Main parts illustrated in the drawings will be described, and the description of other parts will be omitted.

In the following description, a six-unit tandem image forming apparatus in which six image forming units are arranged will be described as an example of the image forming apparatus according to the present exemplary embodiment. The tandem image forming apparatus is not limited to this, and may be a five-unit tandem image forming apparatus in which five image forming units are arranged, a four-unit tandem image forming apparatus in which four image forming units are arranged, or the like.

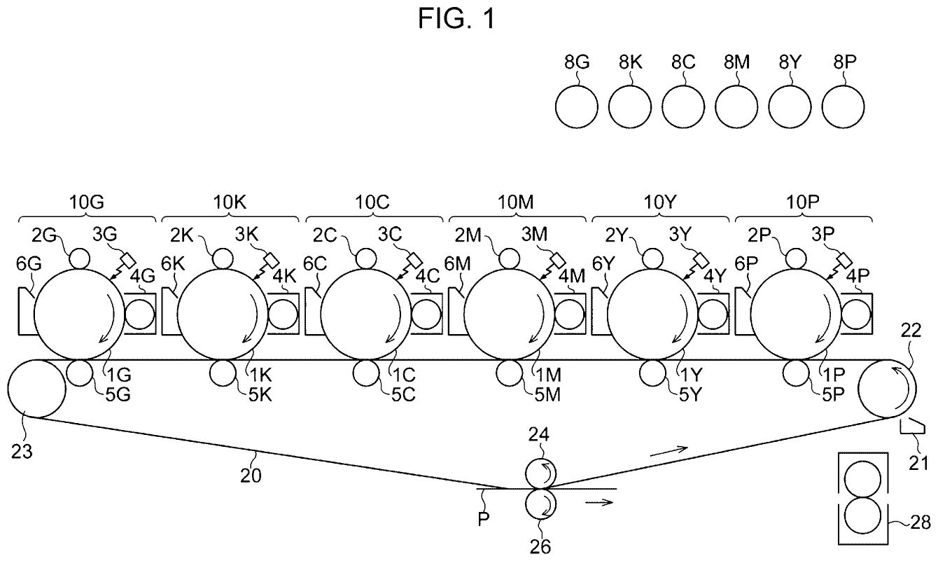

FIG. 1 is a schematic configuration view illustrating a six-unit tandem intermediate transfer type image forming apparatus as the image forming apparatus according to the present exemplary embodiment.

The image forming apparatus illustrated in FIG. 1 includes first to sixth image forming units 10P, 10Y, 10M, 10C, 10K, and 10G, which are electrophotographic image forming units for outputting images of respective colors of pink (P), yellow (Y), magenta (M), cyan (C), black (K), and green (G) based on color-separated image data. These image forming units (hereinafter, may simply be referred to as “units”) 10P, 10Y, 10M, 10C, 10K, and 10G are arranged at a predetermined distance in the horizontal direction. These units 10P, 10Y, 10M, 10C, 10K, and 10G may be process cartridges that are attachable to and detachable from the image forming apparatus.

On the lower sides of the units 10P, 10Y, 10M, 10C, 10K, and 10G, an intermediate transfer belt (an example of the intermediate transfer member) 20 extends through the units. The intermediate transfer belt 20 is provided so as to be wound around a drive roll 22, a support roll 23, and a counter roll 24, which are in contact with the inner surface of the intermediate transfer belt 20. The intermediate transfer belt 20 travels in a direction from the first unit 10P toward the sixth unit 10G. An intermediate transfer member cleaning device 21 is provided on the image holding surface side of the intermediate transfer belt 20 so as to oppose the drive roll 22.

Developing devices (an example of the developing device) 4P, 4Y, 4M, 4C, 4K, and 4G of the units 10P, 10Y, 10M, 10C, 10K, and 10G are supplied with the respective toners of pink, yellow, magenta, cyan, black, and green contained in respective toner cartridges 8P, 8Y, 8M, 8C, 8K, and 8G.

Since the first to sixth units 10P, 10Y, 10M, 10C, 10K, and 10G have an equivalent configuration and operate in the same manner, the sixth unit 10G that forms a green image will be described here as a representative.

For example, in the second to fifth units 10Y, 10M, 10C, and 10K, non-fluorescent toners in the toner set according to the present exemplary embodiment are used as toners for forming yellow, magenta, cyan, and black images. In the sixth unit 10G, a fluorescent toner in the toner set according to the present exemplary embodiment is used as a toner for forming a green image.

The sixth unit 10G includes a photoreceptor 1G serving as an image holding member. Around the photoreceptor 1G, the following components are arranged in the order of listing: a charging roll (an example of a charging device) 2G that charges the surface of the photoreceptor 1G to a predetermined potential; an exposure device (an example of an electrostatic charge image forming device) 3G that forms an electrostatic charge image by exposing the charged surface to a laser beam based on a color-separated image signal; a developing device (an example of a developing device) 4G that supplies the toner to the electrostatic charge image and develops the electrostatic charge image; a primary transfer roll (an example of a primary transfer device) 5G that transfers the developed toner image onto the intermediate transfer belt 20; and a photoreceptor cleaning device (an example of a cleaning device) 6G that removes toner remaining on the surface of the photoreceptor 1G after the primary transfer.

The primary transfer roll 5G is disposed inside the intermediate transfer belt 20 and is provided at a position opposing the photoreceptor 1G. A bias power supply (not illustrated) that applies a primary transfer bias is connected to each of primary transfer rolls 5Y, 5P, 5M, 5C, 5G, and 5K of the units. Each of the bias power supplies changes the value of a transfer bias applied to each of the primary transfer rolls under the control of a control unit (not illustrated).

The operation of forming a green image in the sixth unit 10G will be described below.

First, before the operation, the surface of the photoreceptor 1G is charged to a potential of −600 V to −800 V by the charging roll 2G.

The photoreceptor 1G is formed by laminating a photosensitive layer on a conductive substrate (e.g., having a volume resistivity of 1×10⁻⁶ Ωcm or less at 20° C.). This photosensitive layer normally has high resistance (a resistance of typical resins); however, this photosensitive layer has a property in which upon irradiation of a laser beam, the specific resistance of a portion of the photosensitive layer irradiated with the laser beam changes. In light of this property, the exposure device 3G irradiates the surface of the charged photoreceptor 1G with a laser beam in accordance with green image data sent from the control unit (not illustrated). With this process, an electrostatic charge image of a green image pattern is formed on the surface of the photoreceptor 1G.

The electrostatic charge image is an image formed on the surface of the photoreceptor 1G by charging. The electrostatic charge image is a so-called negative latent image formed as follows: a laser beam from the exposure device 3G lowers the specific resistance of the irradiated portion of the photosensitive layer; a charge flows on the surface of the photoreceptor 1G; and the charge of a portion not irradiated with the laser beam remains.

The electrostatic charge image formed on the photoreceptor 1G is rotated to a predetermined developing position due to the movement of the photoreceptor 1G. At the developing position, the electrostatic charge image on the photoreceptor 1G is developed and visualized as a toner image by the developing device 4G.

The developing device 4G accommodates, for example, an electrostatic charge image developer containing at least a green toner and a carrier. The green toner is subjected to triboelectrification by being stirred in the developing device 4G, and is held on a developer roll (an example of a developer holding member) having a charge of the same polarity (negative polarity) as the charge on the photoreceptor 1G. As the surface of the photoreceptor 1G passes through the developing device 4G, the green toner electrostatically adheres to the charge-erased latent image portion on the surface of the photoreceptor 1G, and the latent image is developed with the green toner. The photoreceptor 1G on which the green toner image has been formed continues to move at a predetermined speed, and the toner image developed on the photoreceptor 1G is transported to a predetermined primary transfer position.

When the green toner image on the photoreceptor 1G is transported to the primary transfer position, a primary transfer bias is applied to the primary transfer roll 5G, an electrostatic force heading from the photoreceptor 1G toward the primary transfer roll 5G acts on the toner image, and the toner image on the photoreceptor 1G is transferred onto the intermediate transfer belt 20. The transfer bias applied at this time has a (+) polarity opposite to the polarity (−) of the toner, and is controlled to, for example, +10 μA by a control unit (not illustrated) in the first unit 10G.

After the toner image is transferred onto the intermediate transfer belt 20, the photoreceptor 1G continues to rotate and comes into contact with the cleaning blade included in the photoreceptor cleaning device 6G. The toner remaining on the photoreceptor 1G is removed and collected by the photoreceptor cleaning device 6G.

The intermediate transfer belt 20 is sequentially transported through the first to sixth image forming units 10P, 10Y, 10M, 10C, 10K, and 10G, and the toner images of the respective colors are superimposed, so that multiple transfer is performed.

The intermediate transfer belt 20, onto which the toner images of six colors are subjected to multiple transfer through the first to sixth units, reaches a secondary transfer portion. The secondary transfer portion includes the intermediate transfer belt 20, the counter roll 24 in contact with the inner surface of the intermediate transfer belt 20, and a secondary transfer roll (an example of a secondary transfer device) 26 disposed on the image holding surface side of the intermediate transfer belt 20. On the other hand, a recording sheet (an example of a recording medium) P is fed through a supply mechanism to a portion where the secondary transfer roll 26 and the intermediate transfer belt 20 are in contact with each other and a sheet-passable gap will be created at a predetermined timing, and a secondary transfer bias is applied to the counter roll 24. The transfer bias applied at this time has a (−) polarity that is the same polarity as the polarity (−) of the toner. An electrostatic force heading from the intermediate transfer belt 20 toward the recording sheet P acts on the toner image, and the toner image on the intermediate transfer belt 20 is transferred onto the recording sheet P. This secondary transfer bias is determined in accordance with the resistance detected by a resistance detection device (not illustrated) that detects the resistance of the secondary transfer portion, and the voltage thereof is controlled.

After the toner image is transferred onto the recording sheet P, the intermediate transfer belt 20 continues to travel and comes into contact with the cleaning blade included in the intermediate transfer member cleaning device 21. The toner remaining on the intermediate transfer belt 20 is removed and collected by the intermediate transfer member cleaning device 21.

The recording sheet P onto which the toner image has been transferred is sent to a pressure contact portion (nip portion) of a pair of fixing rolls in a fixing device (an example of a fixing device) 28. The toner image is fixed on the recording sheet P, and a fixed image is formed.

Examples of the recording sheet P onto which the toner image is transferred include plain paper used in an electrophotographic copying machine, a printer, and the like. Examples of the recording medium include an overhead projector (OHP) sheet in addition to the recording sheet P.

For further improving the smoothness of the image surface after fixing, the surface of the recording sheet P is also preferably smooth. For example, coated paper obtained by coating the surface of plain paper with a resin or the like, art paper for printing, or the like is suitably used.

The recording sheet P on which the fixing of the color image has been completed is carried toward the discharge portion, and a series of color image forming operations are completed.

### Process Cartridge and Toner Cartridge

The process cartridge according to the present exemplary embodiment will be described.

The process cartridge according to the present exemplary embodiment is a process cartridge that includes a developing device accommodating the electrostatic charge image developer according to the present exemplary embodiment and developing the electrostatic charge image formed on the surface of the image holding member as a toner image with the electrostatic charge image developer, and that is attached to and detached from the image forming apparatus.

The configuration of the process cartridge according to the present exemplary embodiment is not limited to the above-described configuration. The process cartridge according to the present exemplary embodiment may include the developing device and, if necessary, at least one selected from other devices such as an image holding member, a charging device, an electrostatic charge image forming device, and a transfer device.

Hereinafter, an example of the process cartridge according to the present exemplary embodiment will be described, but the present disclosure is not limited thereto. In the following description, main parts illustrated in the drawings will be described, and the description of other parts will be omitted.

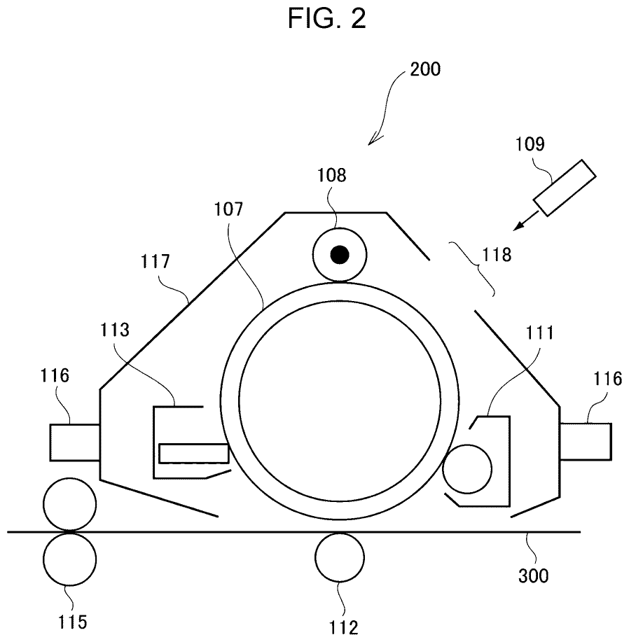

FIG. 2 is a schematic configuration view illustrating the process cartridge according to the present exemplary embodiment.

For example, a process cartridge 200 illustrated in FIG. 2 includes a housing 117 including a mounting rail 116 and an opening 118 for exposure, a photoreceptor 107 (an example of an image holding member), a charging roll 108 (an example of a charging device) provided around the photoreceptor 107, a developing device 111 (an example of a developing device), and a photoreceptor cleaning device 113 (an example of a cleaning device). In the process cartridge 200, the housing 117 integrally combines and holds the photoreceptor 107, the charging roll 108, the developing device 111, and the photoreceptor cleaning device 113 and is formed into a cartridge.

In FIG. 2, a reference numeral 109 denotes an exposure device (an example of an electrostatic charge image forming device), a reference numeral 112 denotes a transfer device (an example of a transfer device), a reference numeral 115 denotes a fixing device (an example of a fixing device), and a reference numeral 300 denotes a recording sheet (an example of a recording medium).

Next, the toner cartridge according to the present exemplary embodiment will be described.

The toner cartridge according to the present exemplary embodiment is a toner cartridge that accommodates the green toner according to the present exemplary embodiment and is attached to and detached from the image forming apparatus. The toner cartridge is a member for accommodating a toner to be supplied to the developing device provided in the image forming apparatus.

The image forming apparatus illustrated in FIG. 1 is an image forming apparatus having a configuration in which the toner cartridges 8P, 8Y, 8M, 8C, 8K, and 8G are attached thereto and detached therefrom. The developing devices 4P, 4Y, 4M, 4C, 4K, and 4G are connected to the toner cartridges corresponding to the respective colors through toner supply tubes (not illustrated). When the amount of toner accommodated in the toner cartridge runs low, the toner cartridge will be replaced with a new one.

The toner cartridges 8P, 8Y, 8M, 8C, 8K, and 8G accommodate toners of pink, yellow, magenta, cyan, black, and green, respectively.

An example of the first toner cartridge in the toner cartridge set according to the present exemplary embodiment is the toner cartridge 8G, which accommodates the fluorescent toner in the toner set according to the present exemplary embodiment.

Examples of the second toner cartridges in the toner cartridge set according to the present exemplary embodiment include the toner cartridges 8Y, 8M, 8C, and 8K, which each accommodate a non-fluorescent toner in the toner set according to the present exemplary embodiment.

### EXAMPLES

Hereinafter, the exemplary embodiments of the present disclosure will be described in detail with reference to Examples, but the exemplary embodiments of the present disclosure are not limited to these Examples.

In the following description, “part(s)” and “%” are all based on mass unless otherwise specified.

Synthesis, treatment, production, and the like are performed at room temperature (25° C. 3° C.) unless otherwise specified.

### Preparation of Resin Particle Dispersion Liquid

### Preparation of Resin Particle Dispersion Liquid (1)

Terephthalic acid: 30 parts by mole
Fumaric acid: 70 parts by mole
Bisphenol A ethylene oxide adduct: 5 parts by mole
Bisphenol A propylene oxide adduct: 95 parts by mole

The above-described materials are charged into a flask equipped with a stirrer, a nitrogen inlet tube, a temperature sensor, and a rectifying column, the temperature is raised to 220° C. over one hour, and 1 part of titanium tetraethoxide is added to 100 parts of the above-described materials. The temperature is raised to 230° C. over 30 minutes while the generated water is distilled off, and the dehydration condensation reaction is continued for one hour at the same temperature. Thereafter, the reaction product is cooled. In this manner, a polyester resin having a weight-average molecular weight of 18,000 and a glass transition temperature of 60° C. is obtained.

A vessel equipped with a temperature adjuster and a nitrogen purge unit is charged with 40 parts of ethyl acetate and 25 parts of 2-butanol to obtain a mixed solvent, and 100 parts of the polyester resin is gradually added thereto and dissolved. A 10%-by-mass ammonia aqueous solution (an amount equivalent to 3 times the acid value of the resin in terms of molar ratio) is added thereto, and the mixture is stirred for 30 minutes. Next, the inside of the vessel is purged with dry nitrogen, the temperature is maintained at 40° C., and 400 parts of ion-exchanged water is added dropwise to the liquid mixture at a rate of 2 parts/min under stirring. After completion of the dropwise addition, the temperature is returned to room temperature (20° C. to 25° C.), and the mixture is bubbled with dry nitrogen for 48 hours under stirring to reduce the concentrations of ethyl acetate and 2-butanol to 1,000 ppm or less, thereby obtaining a resin particle dispersion liquid. The solid content is adjusted to 20% by mass by adding ion-exchanged water to the resin particle dispersion liquid, thereby obtaining a resin particle dispersion liquid (1).

### Preparation of Pigment Dispersion Liquid

### Preparation of Fluorescent Yellow Pigment Dispersion Liquid (FY1)

Fluorescent yellow pigment (C.I. Pigment Yellow 101 (Radglo VSF-0-01, manufactured by Radiant Color NV, emission peak wavelength: 520 nm)): 70 parts
Anionic surfactant (NEOPELEX G-65, manufactured by Kao Corporation): 4 parts
Ion-exchanged water: 200 parts

The above components are mixed and pulverized to a size of 0.3 μm using a continuous key mill (KMC-3) to adjust the solid content to 20% by mass, thereby obtaining a fluorescent yellow pigment dispersion liquid (FY1) having a volume-average particle diameter of 300 nm.

### Preparation of Non-fluorescent Green Pigment Dispersion Liquid (G1)

Non-fluorescent green pigment (C.I. Pigment Green 36 (LIONOL GREEN 8624, manufactured by TOYOCOLOR Co., Ltd., reflection peak wavelength: 510 nm)): 70 parts
Anionic surfactant (NEOPELEX G-65, manufactured by Kao Corporation): 4 parts
Ion-exchanged water: 200 parts

The above components are mixed and pulverized to a size of 0.2 μm using a continuous key mill (KMC-3) to adjust the solid content to 20% by mass, thereby obtaining a non-fluorescent pigment dispersion liquid (G1) having a volume-average particle diameter of 200 nm.

### Preparation of Non-fluorescent Magenta Pigment Dispersion Liquid (M1)

Non-fluorescent magenta pigment (“C.I. Pigment Red 122”, manufactured by Zeya Chemicals): 110 parts
Anionic surfactant (NEOGEN RK, manufactured by DKS Co., Ltd.): 30 parts (solid content: 20%)
Ion-exchanged water: 300 parts

The above materials are mixed and dispersed for 10 minutes using a homogenizer (ULTRA-TURRAX T50, manufactured by IKA-Werke GmbH & Co. KG). Ion-exchanged water is added to the resulting dispersion liquid to obtain a pigment dispersion liquid (M1) having a solid content of 20% by mass. The volume-average particle diameter of the non-fluorescent magenta pigment in the non-fluorescent magenta pigment dispersion liquid (M1) is 220 nm.

### Preparation of Release Agent Particle Dispersion Liquid

### Preparation of Release Agent Particle Dispersion Liquid (1)

Ester-based wax (Nissan Electol WEP-5, manufactured by NOF Corporation): 100 parts
Anionic surfactant (NEOGEN RK, manufactured by DKS Co., Ltd.): 1 part
Ion-exchanged water: 350 parts

The above-described materials are mixed, heated to 100° C., and dispersed using a homogenizer (ULTRA-TURRAX T 50, manufactured by IKA-Werke GmbH & Co. KG). Then, the dispersed mixture is subjected to a dispersion treatment using a Manton-Gaulin high-pressure homogenizer (Manton-Gaulin Company), thereby obtaining a release agent particle dispersion liquid (1) (solid content: 20% by mass) in which release agent particles having a volume-average particle diameter of 200 nm are dispersed.

### Example 1

### Production of Fluorescent Toner

Resin particle dispersion liquid (1): 385 parts
Fluorescent yellow pigment dispersion liquid (FY1): 35 parts
Non-fluorescent green pigment dispersion liquid (G1): 15 parts
Release agent particle dispersion liquid (1): 5 parts
Anionic surfactant (NEOGEN RK, manufactured by DKS Co., Ltd., 20%): 10 parts

The above-described materials are placed in a round stainless steel flask, 0.1 N (i.e., mol/L) of nitric acid is added to adjust the pH to 3.5, and 30 parts of a nitric acid aqueous solution having a polyaluminum chloride concentration of 10% by mass is added.

Next, the mixture is dispersed at a liquid temperature of 30° C. using a homogenizer (product name: ULTRA-TURRAX T 50, manufactured by IKA-Werke GmbH & Co. KG), heated to 45° C. in a heating oil bath, and held for 30 minutes.

Thereafter, 50 parts of the resin particle dispersion liquid (1) is added and held for 1 hour.

The pH is then adjusted to 8.5 by adding a 0.1 N sodium hydroxide aqueous solution, and the mixture is heated to 84° C. and held for 2.5 hours.

The mixture is then cooled to 20° C. at a rate of 20° C./min, and the solid matter is separated by filtration, sufficiently washed with ion-exchanged water, and dried to obtain fluorescent toner particles. The obtained fluorescent toner particles have a volume-average particle diameter of 5.8 μm.

Using a sample mill, 100 parts by mass of the fluorescent toner particles and 3.0 parts by mass of silica particles (“RY50” manufactured by NIPPON AEROSIL Co., Ltd.) are mixed and blended at 10,000 revolutions per minute (rpm) for 30 seconds. Furthermore, 0.05 parts of zinc stearate particles are added to the mixture and blended for 30 seconds in the same manner. Thereafter, the mixture is sieved through a vibration sieve having an opening of 45 μm to obtain a fluorescent toner.

### Production of Non-Fluorescent Toner

Resin particle dispersion liquid (1): 385 parts
Non-fluorescent magenta pigment dispersion liquid (M1): 50 parts
Release agent particle dispersion liquid (1): 5 parts
Anionic surfactant (NEOGEN RK, manufactured by DKS Co., Ltd., 20%): 10 parts

The above-described materials are placed in a round stainless steel flask, 0.1 N (i.e., mol/L) of nitric acid is added to adjust the pH to 3.5, and 30 parts of a nitric acid aqueous solution having a polyaluminum chloride concentration of 10% by mass is added.

Next, the mixture is dispersed at a liquid temperature of 30° C. using a homogenizer (product name: ULTRA-TURRAX T 50, manufactured by IKA-Werke GmbH & Co. KG), heated to 40° C. in a heating oil bath, and held for 30 minutes.

Thereafter, 50 parts of the resin particle dispersion liquid (1) is added and held for 1 hour.

The pH is then adjusted to 8.5 by adding a 0.1 N sodium hydroxide aqueous solution, and the mixture is heated to 84° C. and held for 2.5 hours.

The mixture is then cooled to 20° C. at a rate of 20° C./min, and the solid matter is separated by filtration, sufficiently washed with ion-exchanged water, and dried to obtain non-fluorescent magenta toner particles. The obtained non-fluorescent magenta toner particles have a volume-average particle diameter of 4.7 μm.

Using a sample mill, 100 parts by mass of the non-fluorescent magenta toner particles and 3.0 parts by mass of silica particles (“RY50” manufactured by NIPPON AEROSIL Co., Ltd.) are mixed and blended at 10,000 revolutions per minute (rpm) for 30 seconds. Furthermore, 0.05 parts of zinc stearate particles are added to the mixture and blended for 30 seconds in the same manner. Thereafter, the mixture is sieved through a vibration sieve having an opening of 45 μm to obtain a non-fluorescent magenta toner.

A non-fluorescent yellow toner and a non-fluorescent cyan toner are obtained in the same manner as above, except that the non-fluorescent magenta pigment dispersion liquid is changed to the pigment dispersion liquid of the corresponding color.

A toner set of the fluorescent toner and the non-fluorescent toners (non-fluorescent yellow toner, non-fluorescent magenta toner, and non-fluorescent cyan toner) obtained through the above operations is defined as a toner set of Example 1.

### Example 2

A fluorescent toner is obtained in the same manner as in Example 1, except that the anionic surfactant is changed to 4.5 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 25 parts (solid content: 20%) of the anionic surfactant (NEOGEN RK, manufactured by DKS Co., Ltd.) in the production of the non-fluorescent toners.

### Example 3

A fluorescent toner is obtained in the same manner as in Example 1, except that the anionic surfactant is changed to 4.5 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 28 parts (solid content: 20%) of the anionic surfactant (NEOGEN RK, manufactured by DKS Co., Ltd.) in the production of the non-fluorescent toners.

### Example 4

A fluorescent toner is obtained in the same manner as in Example 1, except that the anionic surfactant is changed to 3.5 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 35 parts (solid content: 20%) of the anionic surfactant (NEOGEN RK, manufactured by DKS Co., Ltd.) in the production of the non-fluorescent toners.

### Example 5

A fluorescent toner is obtained in the same manner as in Example 1, except that the anionic surfactant is changed to 3.0 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 35 parts (solid content: 20%) of the anionic surfactant (NEOGEN RK, manufactured by DKS Co., Ltd.) in the production of the non-fluorescent toners.

### Example 6

A fluorescent toner is obtained in the same manner as in Example 1, except that the anionic surfactant is changed to 2.0 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 23 parts (solid content: 20%) of the anionic surfactant (NEOGEN RK, manufactured by DKS Co., Ltd.) in the production of the non-fluorescent toners.

### Example 7

A fluorescent toner is obtained in the same manner as in Example 1, except that the anionic surfactant is changed to 2.5 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 23 parts (solid content: 20%) of the anionic surfactant (NEOGEN RK, manufactured by DKS Co., Ltd.) in the production of the non-fluorescent toners.

### Example 8

A fluorescent toner is obtained in the same manner as in Example 1, except that the anionic surfactant is changed to 5.0 parts of the anionic surfactant (NEOPELEX G-65, manufactured by Kao Corporation) in the production of the fluorescent toner.

Non-fluorescent toners of the corresponding colors are obtained in the same manner as in Example 1, except that the anionic surfactant is changed to 25 parts (solid content: 20%) of the anionic surfactant (NEOGEN RK, manufactured by DKS Co., Ltd.) in the production of the non-fluorescent toners.

### Example 9

A fluorescent toner is obtained in the same manner as in Example 1, except that the anionic surfactant is changed to 6.0 parts of the anionic surfactant (NEOPELEX G-65, manufactured by Kao Corporation) in the production of the fluorescent toner.

Non-fluorescent toners of the corresponding colors are obtained in the same manner as in Example 1.

### Example 10

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 20 minutes”.

Non-fluorescent toners of the corresponding colors are obtained in the same manner as in Example 1, except that, in the production of the non-fluorescent toners, the anionic surfactant is changed to 25 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 35 minutes”.

### Example 11

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 20 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 35 minutes”.

### Example 12

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 20 minutes”.

Non-fluorescent toners of the corresponding colors are obtained in the same manner as in Example 1, except that the anionic surfactant is changed to 28 parts (solid content: 20%) of the anionic surfactant (NEOGEN RK, manufactured by DKS Co., Ltd.) in the production of the non-fluorescent toners.

### Example 13

A fluorescent toner is obtained in the same manner as in Example 1.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 25 minutes”.

### Example 14

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 33 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 25 minutes”.

### Example 15

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 20 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 25 minutes”.

### Example 16

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 23 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 25 minutes”.

### Example 17

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 40 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 35 minutes”.

### Example 18

A fluorescent toner is obtained in the same manner as in Example 1, except that, in the production of the fluorescent toner, the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 45° C. in a heating oil bath, and held for 42 minutes”.

Non-fluorescent toners of the corresponding colors are obtained in the same manner as in Example 1, except that, in the production of the non-fluorescent toners, the anionic surfactant is changed to 28 parts (solid content: 20%) of the anionic surfactant (NEOGEN RK, manufactured by DKS Co., Ltd.), and the dispersion conditions for the materials initially charged into the round stainless steel flask are changed to “the materials are dispersed using a homogenizer (ULTRA-TURRAX T 50, manufactured by IKA-Werke GmbH & Co. KG) at a liquid temperature of 30° C., heated to 40° C. in a heating oil bath, and held for 35 minutes”.

### Example 19

A fluorescent toner is obtained in the same manner as in Example 1, except that the anionic surfactant is changed to 6.0 parts of the anionic surfactant (NEOPELEX G-65, manufactured by Kao Corporation) in the production of the fluorescent toner.

For the production of the non-fluorescent toners, non-fluorescent toners of the corresponding colors are obtained in the same manner as in Example 1.

### Example 20

A fluorescent toner is obtained in the same manner as in Example 1, except that the anionic surfactant is changed to 5.0 parts of the anionic surfactant (NEOPELEX G-65, manufactured by Kao Corporation) in the production of the fluorescent toner.

For the production of the non-fluorescent toners, non-fluorescent toners of the corresponding colors are obtained in the same manner as in Example 1.

### Example 21

A fluorescent toner is obtained in the same manner as in Example 1, except that the anionic surfactant is changed to 3.5 parts of the anionic surfactant (NEOPELEX G-65, manufactured by Kao Corporation) in the production of the fluorescent toner.

For the production of the non-fluorescent toners, non-fluorescent toners of the corresponding colors are obtained in the same manner as in Example 1.

### Example 22

A fluorescent toner is obtained in the same manner as in Example 1, except that the anionic surfactant is changed to 3.0 parts of the anionic surfactant (NEOPELEX G-65, manufactured by Kao Corporation) in the production of the fluorescent toner.

For the production of the non-fluorescent toners, non-fluorescent toners of the corresponding colors are obtained in the same manner as in Example 1.

### Comparative Example 1

A fluorescent toner is obtained in the same manner as in Example 1, except that the anionic surfactant is changed to 7.0 parts of the anionic surfactant (NEOPELEX G-65, manufactured by Kao Corporation) in the production of the fluorescent toner.

For the production of the non-fluorescent toners, non-fluorescent toners of the corresponding colors are obtained in the same manner as in Example 1.

### Comparative Example 2

In the production of the fluorescent toner, toner particles are produced by a kneading and pulverizing method as follows.
Amorphous polyester resin (weight-average molecular weight: 18,000, glass transition temperature: 60° C.): 160 parts
C.I. Pigment Yellow 101: 14 parts
C.I. Pigment Green 36: 6 parts
Paraffin wax (HNP-9, NIPPON SEIRO Co., Ltd.): 20 parts

The above materials are charged into a Henschel mixer (FM75L, Nippon Coke & Engineering Co., Ltd.) and mixed by rotating the mixer at a rotational speed of 20/sec for 15 minutes to obtain a toner composition. Subsequently, the toner composition is kneaded with a twin-screw kneading extruder (TEM-48SS, Shibaura Machine Co., Ltd.) set to a temperature of 150° C., and the kneaded product is rolled and cooled to 30° C. or lower. The resulting kneaded product is coarsely pulverized to 1 mm or less with a hammer mill, and is then finely pulverized with a jet mill (AFG, HOSOKAWA MICRON Corporation). Classification is performed with an elbow jet classifier (EJ-LABO, Nittetsu Mining Co., Ltd.) to obtain green toner particles having a volume-average particle diameter of 5.7 μm. Thereafter, a fluorescent toner is obtained in the same manner as in Example 1.

For the production of the non-fluorescent toners, non-fluorescent toners of the corresponding colors are obtained in the same manner as in Example 1.

### Evaluation 1

### Evaluation of Properties

The following properties of the toners in the toner sets of Examples 4 to 9 and 11 to 22 and Comparative Example 2 are measured as described above.
X-ray fluorescence intensity CI_{F} of S element contained in fluorescent toner particles
X-ray fluorescence intensity CI_{C} of S element contained in non-fluorescent toner particles
Volume-average particle diameter D_{F} of fluorescent toner particles
Volume-average particle diameter D_{C} of non-fluorescent toner particles

### Production of Developer

A developer is obtained as follows using each of the toners in the toner sets of Examples.

A V blender is charged with 10 parts of each of the toners in the toner sets of Examples and 100 parts of a carrier described below, and the materials are stirred for 20 minutes. The mixture is then sieved using a sieve having an opening of 212 μm to obtain a developer.

### Carrier

Cyclohexyl methacrylate resin (weight-average molecular weight 50000): 54 parts
Carbon black (VXC72, manufactured by Cabot Corporation): 6 parts
Toluene: 250 parts
Isopropyl alcohol: 50 parts

The above-described materials and glass beads (diameter: 1 mm, the same amount as toluene) are charged into a sand mill and stirred at a rotational speed of 190 rpm for 30 minutes to obtain a coating agent.

Into a kneader, 1000 parts of ferrite particles (volume-average particle diameter: 35 μm) and 150 parts of the coating agent are charged, and both are mixed at room temperature (25° C.) for 20 minutes. The mixture is then heated to 70° C. and dried under reduced pressure. The dried product is cooled to room temperature (25° C.), taken out from the kneader, and sieved by using a mesh having an opening of 75 μm to remove coarse powder, thereby obtaining a carrier.

Evaluation using Actual Device

A developing device for each color in an image forming apparatus “Iridesse Production Press” manufactured by FUJIFILM Business Innovation Corp. is filled with a developer for the corresponding color using the corresponding toner in the toner sets of Examples. The obtained image forming apparatus is used as an image forming apparatus for evaluation.

### Secondary Transfer Efficiency

With the image forming apparatus for evaluation, the developing potential is adjusted so that the amount of each of the fluorescent toner and the non-fluorescent toner in a single color applied on the photoreceptor is 5 g/m² in an environment at a temperature of 10° C. and a relative humidity of 20%.

Subsequently, an image is formed by superimposing the fluorescent toner and the non-fluorescent toner at a ratio of 1:1 as a secondary color. The evaluation apparatus is stopped immediately after the toner developed on the photoreceptor is transferred to the intermediate transfer belt. The superimposed image portion transferred to the intermediate transfer belt is picked up with a mending tape, and the weight of the toner at that time is measured.

Then, the evaluation apparatus is restarted and, at this time, is stopped immediately after the toner is transferred from the intermediate transfer belt to a sheet by a secondary transfer unit. The superimposed image portion transferred to the sheet is blown off, and the amount of applied toner is measured from the difference in weight.

Based on the ratio between the amount of toner applied to the intermediate transfer belt and the amount of toner applied to the sheet after the secondary transfer, the transfer efficiency is calculated from the following formula.

The primary transfer condition for the fluorescent toner is a condition under which the minimum value of the transfer efficiency of the non-fluorescent toner is 90% when the transfer voltage is changed. The secondary transfer condition is a condition under which the minimum value of the secondary transfer efficiency from the intermediate transfer belt to the sheet is 90% when an image is formed by superimposing two layers of the non-fluorescent toner. The transfer efficiency is measured after images having an image area of 5% are continuously output on 1,000 A4-sheets.

$$Secondary transfer efficiency = Amount of toner applied to sheet / Amount of toner applied to intermediate transfer belt \times 100$$

The evaluation criteria for the secondary transfer efficiency are as follows.
A: The secondary transfer efficiency is 98% or more.
B: The secondary transfer efficiency is 95% or more and less than 98%.
C: The secondary transfer efficiency is 90% or more and less than 95%.
D: The secondary transfer efficiency is less than 90%.

### Chroma

With the image forming apparatus for evaluation, halftone images of 5 cm×5 cm patches controlled to have a lightness L* of 75 (extreme highlight region) and a lightness L* of 65 (highlight region) by changing the image area ratio of an image obtained by superimposing the fluorescent toner and the non-fluorescent cyan toner are output to generate evaluation images, and the gray tone is evaluated.

For the halftone images, the chroma C* is determined by the above-described method and evaluated based on the following criteria.
A: The chroma is more than 90.
B: The chroma is more than 85 and 90 or less.
C: The chroma is more than 80 and 85 or less.
D: The chroma is 80 or less.

For the chroma C* and the lightness L*, an image is measured 10 times at random using an eXact Advanced (aperture 4 mm, manufactured by X-Rite Inc.), and the color gamut of the image obtained by averaging the measured values is used as color reproduction measurement values (L*, a*, and b*). From the obtained color reproduction measurement values (L*, a*, and b*), the lightness (L*) is determined, and the chroma (C*) is calculated from the following formula.

$$Chroma ( {C}^{*} ) = {( {( {a}^{*} )}^{2} + {( {b}^{*} )}^{2} )}^{1 / 2} \qquad Evaluation 2$$

For the toner sets of Examples 1, 2, 3, and 10 and Comparative Example 1, the evaluation of properties and the evaluation using actual device are performed in the same manner as in Evaluation 1.

TABLE

| | Non- | | | | | | | | | |
|---|---|---|---|---|---|---|---|---|---|---|
| | fluorescent toner | | Fluorescent toner | | | | | | | |
| | X-ray | | X-ray | | | | | | | |
| | fluorescence | | fluorescence | | | | | | | |
| | intensity | | intensity | | | | | | | |
| | CI_{C} of | | CI_{F} of | | | | | | | |
| | S element | Particle | S element | Particle | Type of | Amount of | | | Evaluation | |
| | in toner | diameter | in toner | diameter | fluorescent | fluorescent | | | Secondary | |
| | particles | D_{C} | particles | D_{F} | pigment | colorant | CI_{C}-CI_{F} | D_{F}-D_{C} | transfer | |
| | (kcps) | (μm) | (kcps) | (μm) | — | % by mass | (kcps) | (μm) | efficiency | Chroma |
| Example 1 | 1.2 | 4.7 | 0.7 | 5.8 | PY101 | 7 | 0.5 | 1.1 | A | A |
| Example 2 | 1 | 4.9 | 0.8 | 5.7 | PY101 | 7 | 0.2 | 0.8 | C | B |
| Example 3 | 1.1 | 4.9 | 0.8 | 5.7 | PY101 | 7 | 0.3 | 0.8 | B | A |
| Example 4 | 1.4 | 5 | 0.6 | 5.8 | PY101 | 7 | 0.8 | 0.8 | B | A |
| Example 5 | 1.4 | 5 | 0.5 | 5.8 | PY101 | 7 | 0.9 | 0.8 | C | B |
| Example 6 | 0.9 | 5 | 0.3 | 5.8 | PY101 | 8 | 0.6 | 0.8 | C | B |
| Example 7 | 0.9 | 5 | 0.4 | 5.8 | PY101 | 7 | 0.5 | 0.8 | B | A |
| Example 8 | 1 | 4.9 | 0.9 | 5.8 | PY101 | 7 | 0.5 | 0.9 | B | A |
| Example 9 | 1.2 | 5 | 1 | 5.8 | PY101 | 7 | 0.5 | 0.8 | C | B |
| Example 10 | 1 | 5.2 | 0.7 | 5.2 | PY101 | 7 | 0.3 | (±0) | C | C |
| Example 11 | 1.1 | 5.1 | 0.7 | 5.3 | PY101 | 7 | 0.4 | 0.2 | C | B |
| Example 12 | 1.1 | 5 | 0.7 | 5.3 | PY101 | 7 | 0.4 | 0.3 | B | A |
| Example 13 | 1.1 | 4.5 | 0.7 | 5.8 | PY101 | 7 | 0.4 | 1.3 | B | A |
| Example 14 | 1.1 | 4.5 | 0.7 | 5.9 | PY101 | 7 | 0.4 | 1.4 | C | B |
| Example 15 | 1.1 | 4.3 | 0.7 | 5.2 | PY101 | 7 | 0.4 | 0.9 | C | A |
| Example 16 | 1.1 | 4.3 | 0.7 | 5.3 | PY101 | 7 | 0.4 | 1 | B | A |
| Example 17 | 1.1 | 5.2 | 0.7 | 6.3 | PY101 | 7 | 0.4 | 1.1 | B | A |
| Example 18 | 1.1 | 5.2 | 0.7 | 6.4 | PY101 | 7 | 0.4 | 1.2 | C | A |
| Example 19 | 1.2 | 4.8 | 1 | 5.7 | PY101 | 4 | 0.4 | 0.9 | C | C |
| Example 20 | 1.2 | 4.8 | 0.9 | 5.7 | PY101 | 5 | 0.4 | 0.9 | B | C |
| Example 21 | 1.2 | 4.8 | 0.6 | 5.7 | PY101 | 11 | 0.4 | 0.9 | B | A |
| Example 22 | 1.2 | 4.8 | 0.5 | 5.7 | PY101 | 12 | 0.4 | 0.9 | C | A |
| Comparative | 1.2 | 4.8 | 1.2 | 5.7 | PY101 | 7 | 0 | 0.9 | D | D |
| Example 1 | | | | | | | | | | |
| Comparative | 1.2 | 4.8 | 0 | 5.7 | PY101 | 7 | 1.2 | 0.9 | D | D |
| Example 2 | | | | | | | | | | |

As can be seen from the above results, images exhibiting higher fluorescence intensity with further reduced dot-shaped image defects can be formed in Examples than in Comparative Examples.

### APPENDIX

(((1)))

An electrostatic charge image developing toner set comprising:
a fluorescent toner including fluorescent toner particles containing a fluorescent colorant having an azomethine structure; and
a non-fluorescent toner including non-fluorescent toner particles that contain a non-fluorescent colorant but do not contain a fluorescent colorant,
wherein the fluorescent toner particles and the non-fluorescent toner particles contain an S element, and
when measured by X-ray fluorescence analysis, an X-ray fluorescence intensity CI_{F} of the S element contained in the fluorescent toner particles and an X-ray fluorescence intensity CI_{C} of the S element contained in the non-fluorescent toner particles satisfy a relationship CI_{F}<CI_{C}.
   (((2)))

The electrostatic charge image developing toner set according to (((1))), wherein a difference (CI_{C}−CI_{F}) between the X-ray fluorescence intensity CI_{F} of the S element contained in the fluorescent toner particles and the X-ray fluorescence intensity CI_{C} of the S element contained in the non-fluorescent toner particles is 0.3 kcps or more and 0.8 kcps or less.

(((3)))

The electrostatic charge image developing toner set according to (((1))) or (((2))), wherein the X-ray fluorescence intensity CI_{F} of the S element contained in the fluorescent toner particles is 0.4 kcps or more and 0.9 kcps or less.

(((4)))

The electrostatic charge image developing toner set according to any one of (((1))) to (((3))), wherein a volume-average particle diameter D_{F} of the fluorescent toner particles and a volume-average particle diameter D_{C} of the non-fluorescent toner particles satisfy a relationship D_{C}<D_{F}.

(((5)))

The electrostatic charge image developing toner set according to (((4))), wherein a difference (D_{F}−D_{C}) between the volume-average particle diameter D_{F} of the fluorescent toner particles and the volume-average particle diameter D_{C} of the non-fluorescent toner particles is 0.3 μm or more and 1.8 μm or less.

(((6)))

The electrostatic charge image developing toner set according to (((4))) or (((5))), wherein the volume-average particle diameter D_{F} of the fluorescent toner particles is 5.3 μm or more and 6.3 μm or less.

(((7)))

The electrostatic charge image developing toner set according to any one of (((1))) to (((6))), wherein a content of the fluorescent colorant in the fluorescent toner particles is 5.0% by mass or more and 11.0% by mass or less.

(((8)))

An electrostatic charge image developer set comprising:
a first electrostatic charge image developer containing the fluorescent toner in the electrostatic charge image developing toner set according to any one of (((1))) to (((7))); and
a second electrostatic charge image developer containing the non-fluorescent toner in the electrostatic charge image developing toner set according to any one of (((1))) to (((7))).
   (((9)))

A toner cartridge set detachably attachable to an image forming apparatus, the toner cartridge set comprising:
a first toner cartridge accommodating the fluorescent toner in the electrostatic charge image developing toner set according to any one of (((1))) to (((7))); and
a second toner cartridge accommodating the non-fluorescent toner in the electrostatic charge image developing toner set according to any one of (((1))) to (((7))).
   (((10)))

A process cartridge detachably attachable to an image forming apparatus, the process cartridge comprising:
a first developing device accommodating the first electrostatic charge image developer in the electrostatic charge image developer set according to (((8))); and
a second developing device accommodating the second electrostatic charge image developer in the electrostatic charge image developer set according to (((8))).
   (((11)))

An image forming apparatus comprising:
a first image forming unit that includes a first developing device accommodating the first electrostatic charge image developer in the electrostatic charge image developer set according to (((8))) and that forms a first image with the first electrostatic charge image developer;
a second image forming unit that includes a second developing device accommodating the second electrostatic charge image developer in the electrostatic charge image developer set according to (((8))) and that forms a second image with the second electrostatic charge image developer;
a transfer device that transfers the first image and the second image onto a recording medium; and
a fixing device that fixes the first image and the second image on the recording medium.

What is claimed is:

1. An electrostatic charge image developing toner set comprising:
a fluorescent toner including fluorescent toner particles containing a fluorescent colorant having an azomethine structure; and
a non-fluorescent toner including non-fluorescent toner particles that contain a non-fluorescent colorant but do not contain a fluorescent colorant,
wherein the fluorescent toner particles and the non-fluorescent toner particles contain an S element, and
when measured by X-ray fluorescence analysis, an X-ray fluorescence intensity CI_{F} of the S element contained in the fluorescent toner particles and an X-ray fluorescence intensity CI_{C} of the S element contained in the non-fluorescent toner particles satisfy a relationship CI_{F}<CI_{C}.

2. The electrostatic charge image developing toner set according to claim 1, wherein a difference (CI_{C}−CI_{F}) between the X-ray fluorescence intensity CI_{F} of the S element contained in the fluorescent toner particles and the X-ray fluorescence intensity CI_{C} of the S element contained in the non-fluorescent toner particles is 0.3 kcps or more and 0.8 kcps or less.

3. The electrostatic charge image developing toner set according to claim 1, wherein the X-ray fluorescence intensity CI_{F} of the S element contained in the fluorescent toner particles is 0.4 kcps or more and 0.9 kcps or less.

4. The electrostatic charge image developing toner set according to claim 1, wherein a volume-average particle diameter D_{F} of the fluorescent toner particles and a volume-average particle diameter D_{C} of the non-fluorescent toner particles satisfy a relationship D_{C}<D_{F}.

5. The electrostatic charge image developing toner set according to claim 4, wherein a difference (D_{F}−D_{C}) between the volume-average particle diameter D_{F} of the fluorescent toner particles and the volume-average particle diameter D_{C} of the non-fluorescent toner particles is 0.3 μm or more and 1.8 μm or less.

6. The electrostatic charge image developing toner set according to claim 4, wherein the volume-average particle diameter D_{F} of the fluorescent toner particles is 5.3 μm or more and 6.3 μm or less.

7. The electrostatic charge image developing toner set according to claim 1, wherein a content of the fluorescent colorant in the fluorescent toner particles is 5.0% by mass or more and 11.0% by mass or less.

8. An electrostatic charge image developer set comprising:
a first electrostatic charge image developer containing the fluorescent toner in the electrostatic charge image developing toner set according to claim 1; and
a second electrostatic charge image developer containing the non-fluorescent toner in the electrostatic charge image developing toner set according to claim 1.

9. An electrostatic charge image developer set comprising:
a first electrostatic charge image developer containing the fluorescent toner in the electrostatic charge image developing toner set according to claim 2; and
a second electrostatic charge image developer containing the non-fluorescent toner in the electrostatic charge image developing toner set according to claim 2.

10. An electrostatic charge image developer set comprising:
a first electrostatic charge image developer containing the fluorescent toner in the electrostatic charge image developing toner set according to claim 3; and
a second electrostatic charge image developer containing the non-fluorescent toner in the electrostatic charge image developing toner set according to claim 3.

11. An electrostatic charge image developer set comprising:
a first electrostatic charge image developer containing the fluorescent toner in the electrostatic charge image developing toner set according to claim 4; and
a second electrostatic charge image developer containing the non-fluorescent toner in the electrostatic charge image developing toner set according to claim 4.

12. An electrostatic charge image developer set comprising:
a first electrostatic charge image developer containing the fluorescent toner in the electrostatic charge image developing toner set according to claim 5; and
a second electrostatic charge image developer containing the non-fluorescent toner in the electrostatic charge image developing toner set according to claim 5.

13. An electrostatic charge image developer set comprising:
a first electrostatic charge image developer containing the fluorescent toner in the electrostatic charge image developing toner set according to claim 6; and
a second electrostatic charge image developer containing the non-fluorescent toner in the electrostatic charge image developing toner set according to claim 6.

14. An electrostatic charge image developer set comprising:
a first electrostatic charge image developer containing the fluorescent toner in the electrostatic charge image developing toner set according to claim 7; and
a second electrostatic charge image developer containing the non-fluorescent toner in the electrostatic charge image developing toner set according to claim 7.

15. A toner cartridge set detachably attachable to an image forming apparatus, the toner cartridge set comprising:
a first toner cartridge accommodating the fluorescent toner in the electrostatic charge image developing toner set according to claim 1; and
a second toner cartridge accommodating the non-fluorescent toner in the electrostatic charge image developing toner set according to claim 1.

16. A toner cartridge set detachably attachable to an image forming apparatus, the toner cartridge set comprising:
a first toner cartridge accommodating the fluorescent toner in the electrostatic charge image developing toner set according to claim 2; and
a second toner cartridge accommodating the non-fluorescent toner in the electrostatic charge image developing toner set according to claim 2.

17. A toner cartridge set detachably attachable to an image forming apparatus, the toner cartridge set comprising:
a first toner cartridge accommodating the fluorescent toner in the electrostatic charge image developing toner set according to claim 3; and
a second toner cartridge accommodating the non-fluorescent toner in the electrostatic charge image developing toner set according to claim 3.

18. A toner cartridge set detachably attachable to an image forming apparatus, the toner cartridge set comprising:
a first toner cartridge accommodating the fluorescent toner in the electrostatic charge image developing toner set according to claim 4; and
a second toner cartridge accommodating the non-fluorescent toner in the electrostatic charge image developing toner set according to claim 4.

19. A process cartridge detachably attachable to an image forming apparatus, the process cartridge comprising:
a first developing device accommodating the first electrostatic charge image developer in the electrostatic charge image developer set according to claim 8; and
a second developing device accommodating the second electrostatic charge image developer in the electrostatic charge image developer set according to claim 8.

20. An image forming apparatus comprising:
a first image forming unit that includes a first developing device accommodating the first electrostatic charge image developer in the electrostatic charge image developer set according to claim 8 and that forms a first image with the first electrostatic charge image developer;
a second image forming unit that includes a second developing device accommodating the second electrostatic charge image developer in the electrostatic charge image developer set according to claim 8 and that forms a second image with the second electrostatic charge image developer;
a transfer device that transfers the first image and the second image onto a recording medium; and
a fixing device that fixes the first image and the second image on the recording medium.
